(19) United States
(12) Patent Application Publication
(10) Pub. No.: US 2026/0304136 A1
(43) Pub. Date: Oct. 1, 2026

(54) METHODS AND APPARATUS FOR A WIRELESS NETWORK

(71) Applicant: CANON KABUSHIKI KAISHA, Tokyo (JP)

(72) Inventors: Pierre VISA, Rennes (FR); Pascal LAGRANGE, La Chapelle des Fougeretz (FR); Yacine EL KOLLI, Rennes (FR)

(21) Appl. No.: 19/577,147

(22) Filed: Mar. 24, 2026

(30) Foreign Application Priority Data
Mar. 26, 2025 (GB) 2504448.8
May 6, 2025 (GB) 2506902.2

(51) Int. Cl. H04W 16/10

(52) U.S. Cl. CPC H04W 16/10

(57) ABSTRACT

A method performed by a gNB component of a wireless access backhaul, WAB, node, and an apparatus for a gNB component of a wireless access backhaul, WAB, node, are disclosed. The method comprises initiating a resource coordination with the BH-RAN-node, wherein initiating the resource coordination comprises transmitting a request for resource coordination between the gNB component of the WAB node and the BH-RAN-node, wherein the request for resource coordination comprises an indication of a co-location of the MT component and the gNB component in the WAB node.

### CROSS-REFERENCE TO RELATED APPLICATIONS

This application claims the benefit under 35 U.S.C. § 119(a)-(d) of United Kingdom Patent Application No. 2504448.8, filed on Mar. 26, 2025 and titled "METHODS AND APPARATUS FOR A WIRELESS NETWORK" and United Kingdom Patent Application No. 2506902.2, filed on May 6, 2025 and titled "METHODS AND APPARATUS FOR A WIRELESS NETWORK". Each of the above cited patent applications are incorporated herein by reference in its entirety.

### FIELD OF THE INVENTION

The present invention generally relates to methods and apparatus for a wireless network. In particular, the disclosure relates to methods for use in managing or initiating resource coordination in wireless networks or wireless communication systems. For example, the disclosure relates to methods for use in initiating or managing radio resource coordination in a wireless communication system involving a NG-RAN node, such as a Wireless Access Backhaul, WAB, node, so as to improve the reliability of communications.

### BACKGROUND

Wireless communication systems are largely deployed to address a wide range of applications, from mobile broadband, massive machine type communications to Ultra Reliable Low Latency Communications (URLLC). Such systems allow a plurality of user equipment (UE) or mobile terminals to share the wireless medium to exchange several types of data content (e.g. video, voice, messaging …) over a radio access network (RAN) through one or more base stations (gNBs). The base stations are conventionally wired-connected (e.g. through fiber) to a core network, forming an intermediate network, named backhaul (BH).

Examples of such wireless multiple-access communication systems include systems based on 3rd generation partnership project (3GPP - RTM) standards, such as fourth-generation (4G) Long Term Evolution (LTE) or recent fifth-generation (5G) New Radio (NR) systems, or systems-based IEEE 802.11 standards, such as WiFi.

The demand for network densification increases due to the rising number of users and higher throughput requirement.

Facing the issues of high deployment costs and time of the wired backhaul networks with network densification, 3GPP has proposed, from release 16 for 5G NR, a wireless backhaul, also known as Integrated Access and Backhaul, IAB, where part of the wireless (i.e. radio) spectrum is used for the backhaul connection of base stations instead of fiber. The wireless backhaul communications (between base stations) may use the same radio resources as access communications (between a base station and UEs).

IAB turns out to be a competitive alternative to the fiber-based backhauling in dense areas or areas difficult to cover, as it allows scalable and rapid installations without the burden of cabling the base stations.

IAB is most likely to operate in the millimeter wave (mmWave) band to achieve the required Gbps (gigabits per second) data rate.

Urban environments are usually characterised by a high density of users along with the presence of a significant number of vehicles (e.g. public/private passengers transportation, goods delivery, food trucks …).

3GPP considers that such vehicles could offer an opportunity to increase network coverage and connectivity to the UEs inside the vehicles, or even to UEs in proximity to the vehicles, by installing on these vehicles on-board base stations (or base station elements) that would act as relays. These relays would rely on 5G wireless backhaul (typically IAB, or Integrated Access & Backhaul) for connecting to a fixed donor device. Thus, based upon the fixed IAB foundations set out in Releases 16 and 17, 3GPP considers mobile IAB systems and architecture, as a part of the Release 18 framework, in order to address scenarios focusing on mobile IAB-nodes mounted on vehicles (for example, a bus, a train, a taxi). In such scenarios, mobile IAB-nodes can also be referred to as Vehicle Mounted Relays (VMR), providing 5G coverage/capacity to on-board and/or surrounding UEs.

Some further enhancements for Release 19, concern the need for 5G access for UEs onboard aircrafts, cruise ships, helicopters and vehicles in remote areas with limited sky visibility (e.g. where terrestrial cellular coverage or Wi-Fi coverage is not available), support for onboard/on-site mobile edge computing (MEC), local services, and direct local inter-UE communications, or local gNB deployment in public safety or disaster recovery scenarios. The backhauling links for the base stations providing the 5G access in such scenarios would then be operated over either a terrestrial network (TN), or a non-terrestrial network (NTN), with a possibility to handover communications from a terrestrial network to a non-terrestrial network and vice-versa. Such base stations can be referred to as Wireless Access Backhaul (WAB) nodes, or mobile WAB nodes, or WAB nodes.

In WAB out-band scenario, the frequency bands used by a WAB node for the radio access links to served UEs are different from the frequency bands used for the backhaul links to connect the WAB node to a core network. However, in WAB in-band scenario, the frequency bands are the same for the access links and the backhaul links, which may lead to radio interferences. In band scenarios are very likely to happen as a WAB node can be mobile. Therefore, radio resource coordination involving is required to avoid or to minimize radio interferences in wireless systems comprising WAB nodes.

### SUMMARY

In general, the present disclosure is directed towards initiating and managing resource coordination procedures in a wireless network.

In accordance with a first aspect, there is provided a method in a wireless network, the wireless network comprising a wireless access backhaul, WAB, node comprising a mobile termination, MT, component and a gNB component, wherein the MT component of the WAB node is being served by a backhaul NG-RAN node, BH-RAN-node, in the wireless network, the method performed by the gNB component of the WAB node. The method comprises initiating a resource coordination with the BH-RAN-node, wherein initiating the resource coordination comprises transmitting a request for resource coordination between the gNB component of the WAB node and the BH-RAN-node, wherein the request for resource coordination comprises an indication of a co-location of the MT component and the gNB component in the WAB node.

In accordance with a second aspect, there is provided a method in a wireless network, the wireless network comprising a wireless access backhaul, WAB, node comprising a mobile termination, MT, component and a gNB component, wherein the MT component of the WAB node is being served by a first NG-RAN node in the wireless network, and the wireless network further comprising a second NG-RAN node, the method performed by the gNB component of the WAB node. The method comprises initiating a resource coordination with the second NG-RAN node.

In accordance with a third aspect, there is provided a method in a wireless network, the wireless network comprising a wireless access backhaul, WAB, node comprising a mobile termination, MT, component and a gNB component, wherein the MT component of the WAB node is being served by a first NG-RAN node in the wireless network, and the wireless network further comprising a second NG-RAN node, the method performed by the gNB component of the WAB node. The method comprises receiving a request for resource coordination between the gNB component of the WAB node and the second NG-RAN node, and transmitting a response accepting or rejecting the request for resource coordination between the gNB component of the WAB node and the second NG-RAN node.

In accordance with a fourth aspect, there is provided a method in a wireless network, the wireless network comprising a wireless access backhaul, WAB, node comprising a mobile termination, MT, component and a gNB component, wherein the MT component of the WAB node is being served by a first NG-RAN node in the wireless network, and the wireless network further comprising a second NG-RAN node, the method performed by second NG-RAN node. The method comprises initiating a resource coordination with the gNB component of the WAB node.

In accordance with a fifth aspect, there is provided a method in a wireless network, the wireless network comprising a wireless access backhaul, WAB, node comprising a mobile termination, MT, component and a gNB component, wherein the MT component of the WAB node is being served by a first NG-RAN node in the wireless network, and the wireless network further comprising a second NG-RAN node, the method performed by second NG-RAN node. The method comprises receiving a request for resource coordination between the gNB component of the WAB node and the second NG-RAN node, and transmitting a response accepting or rejecting the request for resource coordination between the gNB component of the WAB node and the second NG-RAN node.

In accordance with a sixth aspect, there is provided a computer program. The computer program comprises instructions which, when the program is executed by at least one processor unit, cause the at least one processing unit to carry out a method according to any one of the first, second, third, fourth and fifth aspects.

In accordance with a seventh aspect, there is provided a computer-readable medium carrying a computer program according to the sixth aspect.

In accordance with an eighth aspect, there is provided an apparatus for a gNB component of a WAB node. The apparatus comprises one or more processing units configured to perform a method according to any one of the first, second and third aspects.

In accordance with a ninth aspect, there is provided an apparatus for a second NG-RAN node. The apparatus comprises one or more processing units configured to perform a method according to any one of the fourth and fifth aspects.

Further example features of the invention are described in other independent and dependent claims.

Any feature in one aspect of the invention may be applied to other aspects of the invention, in any appropriate combination. In particular, method aspects may be applied to apparatus/device/unit aspects, and vice versa.

Furthermore, features implemented in hardware may be implemented in software, and vice versa. Any reference to software and hardware features herein should be construed accordingly. For example, in accordance with other aspects of the invention, there are provided a computer program comprising instructions which, when the program is executed by one or more processing units, cause the one or more processing units to carry out the method of any aspect or example described above and a computer readable storage medium carrying the computer program.

The preceding summary is provided for purposes of summarising some examples to provide a basic understanding of aspects of the subject matter described herein. Accordingly, the above-described features should not be construed to narrow the scope or spirit of the subject matter described herein in any way. Moreover, the above and/or proceeding examples may be combined in any suitable combination to provide further examples, except where such a combination is clearly impermissible or expressly avoided. Other features, aspects, and advantages of the subject matter described herein will become apparent from the following text and the accompanying drawings.

### BRIEF DESCRIPTION OF THE DRAWINGS

Different aspects of the invention will now be described, by way of example only, and with reference to the following drawings in which:

FIG. 1 is a schematic diagram of a communication system in which the present invention may be implemented according to one or more example embodiments;

FIG. 2 is a simplified schematic diagram of a 5G system in which the present invention may be implemented according to one or more example embodiments;

FIG. 3 is a simplified schematic diagram of a 5G system involving a Wireless Access Backhaul (WAB) node, and in which the present invention may be implemented according to one or more example embodiments.

FIG. 4 is a block schematic diagram of an example network node or base station in accordance with one or more embodiments of the invention;

FIG. 5 is a simplified schematic diagram showing an example of a wireless communication system, including a WAB network or WAB network system, in which embodiments and examples of embodiments of the present invention may be implemented;

FIG. 6a is a schematic diagram illustrating the protocol stack associated to the Xn interface in the user plane (Xn-U);

FIG. 6b is a schematic diagram illustrating the protocol stack associated to the Xn interface in the control plane (Xn-C);

FIG. 7 is a schematic diagram showing first example message flows for managing WAB resource coordination between the gNB component of a WAB node and a NG-RAN node;

FIG. 8 is a flowchart of an example method for initiating WAB resource coordination at the gNB component of a WAB node;

FIG. 9 is a flowchart of an example method for initiating WAB resource coordination at a WAB aware backhaul NG-RAN node;

FIG. 10 is a flowchart of an example method for initiating WAB resource coordination at a WAB aware NG-RAN node involved in the handover or dual-connectivity of the MT component of a WAB node;

FIG. 11 is a flowchart of an example method for initiating WAB resource coordination at a WAB aware NG-RAN node in the neighbourhood of a WAB node;

FIG. 12 is a flowchart of an example method for managing at the gNB component of a WAB node the reception of a WAB resource coordination request;

FIG. 13 is a schematic diagram showing second example message flows for managing WAB resource coordination between the gNB component of a WAB node and a WAB aware NG-RAN node;

FIG. 14 is a flowchart of an example method performed by a gNB component of the WAB node in accordance with one or more embodiments of the invention;

FIG. 15 is a flowchart of an example method performed by a gNB component of the WAB node in accordance with one or more embodiments of the invention;

FIG. 16 is a flowchart of an example method performed by a gNB component of the WAB node in accordance with one or more embodiments of the invention;

FIG. 17 is a flowchart of an example method performed by a second NG-RAN node in accordance with one or more embodiments of the invention;

FIG. 18 is a flowchart of an example method performed by a second NG-RAN node in accordance with one or more embodiments of the invention.

### DETAILED DESCRIPTION

Aspects and embodiments of the present disclosure will now be discussed with reference to the accompanying figures. Further aspects and embodiments will be apparent to those skilled in the art.

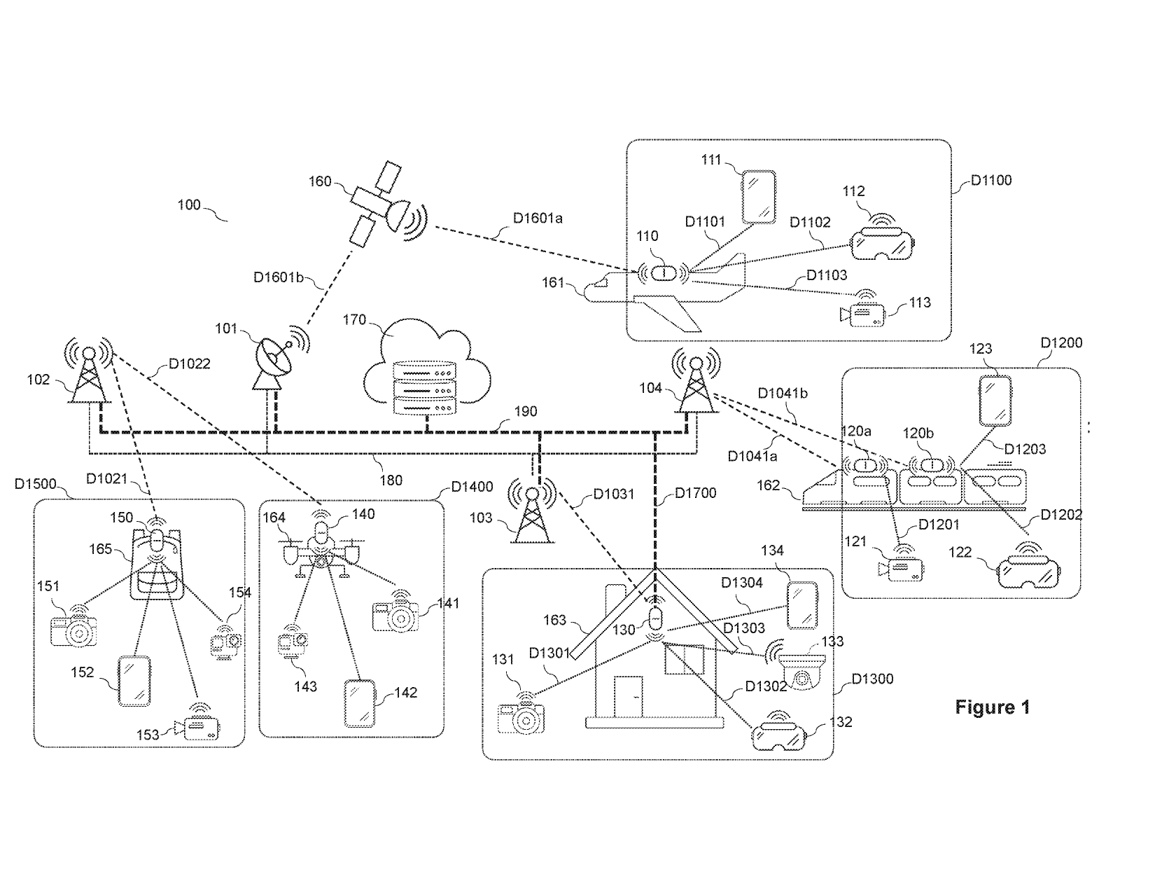

FIG. 1 illustrates an example communication system 100 in which the present invention may be implemented according to one or more embodiments.

As depicted, the example system 100 is a wireless communication system, in particular a mobile radio communication system such as a fifth-generation (5G) New Radio (NR) system including a Wireless Access Backhaul (WAB) communication system or network. Although in the following description, embodiments and examples of embodiments of the present invention will be described with respect to a 5G NR system, it will be appreciated that it is not intended that the present invention is limited to 5G NR systems and may be used in any wireless communication systems having an integrated access and backhaul communication system which shares radio resources for wireless access links and wireless backhaul links.

The system 100 comprises a plurality of UEs (User Equipment) 111, 112, 113, 121, 122, 123, 131, 132, 133, 134, 141, 142, 143, 151, 152, 153 and 154, a communication satellite 160, a satellite dish 101, a remote core network 170, three fixed Base Stations 102, 103 and 104, a plurality of Wireless Access Backhaul (WAB) nodes 110 (mounted on plane 161), 120a and 120b (mounted on train 162), 140 (mounted on Unmanned Aerial Vehicle (UAV) UAV 164) and 150 (mounted on backpack 165 or other carrier that can be carried by a user (e.g. in a disaster zone)), and a Wireless Access Backhaul node 130 (or Home gNB, mounted in house 163) which is fixed but based on the same architecture as a WAB node. In more general terms, the WAB node may be mounted on or in a vehicle (such as a train, bus, taxi, tram, etc.) and/or an aircraft or flying vehicle (such as a plane, UAV, helicopter, etc. ) and/or a building (such as a house, enterprise/company/office building, hotel building, airport building, sports/event buildings, shopping centre building, etc..) and/or a portable carrier that can be carried by a user (such as a backpack, bag, etc.), for example, in a disaster zone or for public safety or for emergency services, and/or public infrastructure elements or units (such as lamp posts, traffic lights, etc.). In an example where the WAB node is implemented in a Femto network, the WAB node functions as a 5G Femto node and may be mounted at a building (such as a house, enterprise/company/office building, hotel building, airport building, sports/event buildings, shopping centre building, etc..) and/or public infrastructure elements or units (such as lamp posts, traffic lights, etc.). When it is a mobile base station, a WAB node is also referred to as a Mobile WAB (MWAB) node.

Some examples of UEs include smartphones/tablets (such as UEs 111, 123, 134, 142, 152), XR headsets (such as UEs 112, 122, 132), cameras (such as UEs 141 and 151), fixed video cameras (such as UEs 113, 121, 133, 153) or mobile/wearable video cameras (such as UEs 143 and 154). In general, the UE may be any portable or handheld or mobile telephone, a smartphone, a tablet, a portable or fixed computer, fixed or mobile camera, portable television or other similar wireless communication device. In the following description, the term UE will be used and it is not intended to limit the description to any particular type of wireless communication device.

Base stations 102, 103 and 104 are interconnected through a wired link infrastructure 180, preferably based on optical fiber or any other wired means.

Base stations 102, 103 and 104 are also connected to the core network 170 through a wired link infrastructure 190, preferably based on optical fiber or any other wired means. In embodiments and examples of embodiments of the invention, base stations 102, 103 and 104 are 5G NR base stations (referred to as a gNB), as defined in 3GPP TS 38.300 v18.0.0 specification document.

Satellite dish 101 (e.g. satellite gateway) is also connected to wired link infrastructure 180 or 190, or to both infrastructures. Besides infrastructures 180 and 190 may be the same infrastructure. In one example, a part of a base station is embedded in the satellite 160 while the other part is embedded in the gateway 101, meaning that the base station is split between the satellite 160 and the gateway 101. In another example, a full base station is embedded in the satellite 160 and the gateway 101 connects the base station 160 with the infrastructure 180 or 190. In case of non-geostationary satellite, the satellite 160 may connect to different gateways, like the gateway 101, while the satellite 160 is moving around the earth.

In order to extend the network coverage of base stations 102, 103, 104, 160/101 and reach the remote UEs 111, 112, 113, 121, 122, 123, 131, 132, 133, 134, 141, 142, 143, 151, 152, 153 and 154, mobile WAB nodes or WAB nodes, or WAB-nodes, 110, 120a, 120b, 130, 140 and 150, have been installed on vehicles / mobile equipment 161, 162, 163, 164 and 165. By acting as relaying nodes between the base stations 102, 103, 104, 160/101 and the UEs 111, 112, 113, 121, 122, 123, 131, 132, 133, 134, 141, 142, 143, 151, 152, 153 and 154, WAB-nodes 110, 120a, 120b, 130, 140 and 150 allow overcoming the reachability issue resulting from limited sky visibility while ensuring support for onboard/on-site mobile edge computing (MEC), local services, and direct local inter-UE communications. This allows further communication between base stations 102, 103 and 104 and the UEs 111, 112, 113, 121, 122, 123, 131, 132, 133, 134, 141, 142, 143, 151, 152, 153 and 154 and/or communications between the UEs served by a same WAB-node (e.g., UEs 151, 152, 153 and 154 connected to WAB node 150).

The base stations 102, 103 and 104, the WAB nodes 110, 120a, 120b, 130, 140 and 150, the satellite 160, the satellite dish 101 are thus forming a backhaul network or WAB network (also referred to as WAB topology), or WAB network (also referred to as WAB topology), which accommodates UEs 111, 112, 113, 121, 122, 123, 131, 132, 133, 134, 141, 142, 143, 151, 152, 153 and 154.

The terms WAB network, WAB network, WAB topology and WAB topology will be used interchangeably in the following. The WAB network is part of the Radio Access Network (RAN) or as referred to with respect to 5G, the Next Generation (NG) RAN.

The base stations 102, 103 and 104, the WAB nodes 110, 120a, 120b, 130, 140 and 150, the satellite 160, the satellite dish 101, and the core network 170 are thus forming a WAB system, or WAB system, which accommodates UEs 111, 112, 113, 121, 122, 123, 131, 132, 133, 134, 141, 142, 143, 151, 152, 153 and 154.

The terms WAB system and WAB system will be used interchangeably in the following.

A base station, or gNB, such as base station 102, 103, 104 or 160/101, is a logical node that provides the NR-connectivity, hosting both higher layer protocols, such as PDCP (Packet Data Convergence Protocol) and RRC (Radio Resource Control) protocols, and lower layer protocols, such as the RLC (Radio Link Control), MAC (Medium Access Control) and physical layer protocols.

The WAB nodes 110, 120a, 120b, 130, 140 and 150, which may serve multiple radio sectors, are wireless backhauled to the base station 102, 103, 104, 160/101 via a single logical hop associated to a single radio link (i.e., radio links D1041a, D1041b, D1031, D1022, D1021), or split into two radio links in the case of satellite relaying (radio links D1601a and D1601b). Although a single logical hop is shown in FIG. 1, it will be appreciated that the WAB nodes could be wirelessly backhauled to the base station over multiple logical hops (for example, similar to the multiple hops provided in an IAB network).

Each WAB node consists of or includes a gNB or RAN node or base station component or entity which is referred to as a WAB-gNB, or WAB base station, and Mobile Termination (MT) component or entity which is referred to as an IAB-MT, or WAB-Mobile Termination. The WAB-gNB functionality on an WAB-node allows or enables the WAB-node to serve UEs. The WAB-MT functionality includes, e.g., physical layer, layer-2, RRC and Non-Access Stratum (NAS) functionalities and allows or enables the WAB-MT to connect to a base station, or gNB, such as base station 102, 103, 104, or 160/101 and to support backhauling of traffic related to the WAB-gNB of the WAB node. The WAB-gNB may also be referred to as a NG-RAN node (of a WAB node) and the WAB-MT may also be referred to as a UE (of a WAB node).

WAB nodes 110, 120a, 120b, 140 and 150 are intended to be mobile devices that will move along with the vehicle they are mounted on. However, these WAB nodes may remain at a fixed location for a significant duration when their associated vehicle is remaining still (e.g., a train may stop at a railway station, a plane may be parked at an airport for a while, a car/truck/fire engine or any other emergency vehicle may be parked nearby a disaster area).

WAB node 130 is likely to remain at fixed location and may be a 5G Femto node, which provides NR access at home or at enterprise premises. In such case, the 5G Femto node 130 may have a direct connection D1700 to the Core Network 170 through the wired link infrastructure 190, which is preferably based on optical fiber or any other wired means.

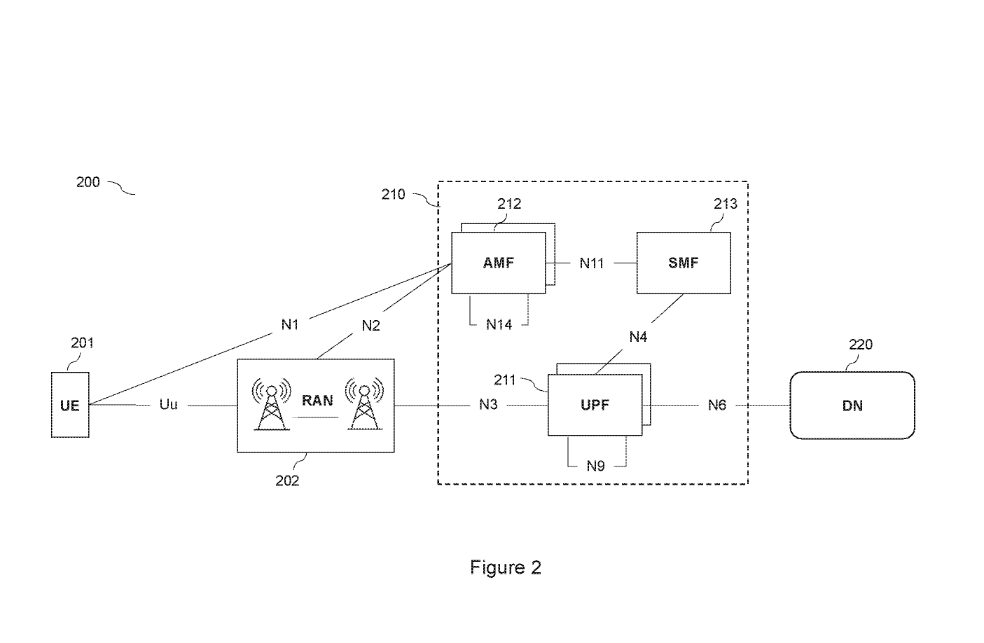

FIG. 2 is a simplified schematic diagram of a 5G system 200 in which the present invention may be implemented according to one or more example embodiments. This figure illustrates the possible standardized interfaces between the various elements composing the system. First, it represents a User Equipment (UE) 201 having a Uu interface with the New Generation (NG) Radio Access Network (RAN or NG-RAN) 202, and a N1 interface with an Access and Mobility management Function (AMF) entity or AMF 212 in a 5G core network (5GC) 210. Each base station composing the RAN 202 has a N2 interface with one or more Access and Mobility management Function (AMF) entity or AMF, like AMF 212, and a N3 interface with one or more User Plane Function (UPF) entity or UPF, like UPF 211.

The N1 interface is used to convey Non-Access Stratum (NAS) protocol messages between a UE 201 and an AMF 212. NAS messages are used for the signaling between the UE and the core network for various procedures such as registration, session establishment, security, and mobility management. Actually, NAS messages are conveyed through the Uu interface between the UE 201 and the RAN 202, and the N2 interface between the RAN 202 and the AMF 212.

An AMF 212 is responsible for handling registration, authentication, connection and mobility management tasks for a UE. For a WAB node, the AMF may apply the procedures defined in NAS protocol specifications (TS 24.502 section 5), considering the WAB node is a Mobile Base Station Relay (MBSR) introduced in Release 18. There may be several AMFs in a 5G core network, a standardized interface N14 enables the communications between AMFs. When a UE registers to the network through a serving base station, the serving base station will connect to an AMF suitable to handle the UE.

When the UE 201 is registered, one or more Protocol Data Unit (PDU) session(s) can be set up to transfer data flows between the UE 201 and the Data Network (DN) 220 providing internet access. A PDU session is established between a UE 201 and a User Plane Function (UPF) 211 in the 5G core network 210. In the user plane, the UPF 211 connects to the Data Network (DN) 220 through the interface N6, and it is responsible for data packets routing with the required Quality of Service (QoS). There may be several UPFs on the data path with a N9 interface between UPFs. The user data between a UE 201 and the Data Network 220 are thus conveyed through interfaces Uu, N3, N6 and potentially N9.

In the control plane, the setup of PDU sessions is handled through NAS messages involving the Session Management Function (SMF) entity or SMF 213 in the 5G core network 210. The NAS messages are still exchanged between the UE 201 and the AMF 212 through theN1interface, but an additional interface N11 between an AMF 212 and the SMF 213 is used to reach the SMF 213. In a 5G core network, the SMF is responsible for the setup, modification, and release of PDU sessions for a UE, as well as the Internet Protocol (IP) address allocation for the UE. To manage a PDU session, the SMF 213 controls the UPF 211 (configuration) based on QoS policy defined for the PDU session. For this purpose, a N4 interface exists between the SMF 213 and the UPF 211.

A base station in RAN 202 operating in a first Public Land Mobile Network (PLMN) may serve a UE having a subscription for a second PLMN (called home PLMN) different from the first PLMN (called visited PLMN). In such a roaming case, there are two options to provide the UE 201 with an access to the Data Network 220. In a first option called home routed, the UPF and its controlling SMF to access the Data Network 220 are located in the 5G core network for the home PLMN. However, the SMF of the visited PLMN controls the intermediate UPF(s) of the visited PLMN, and interacts with the SMF of the home PLMN. In a second option called local breakout, the UPF and its controlling SMF to access the Data Network 220 are located in the 5G core network for the visited PLMN. However, the SMF interacts with the home 5G core network to get QoS policies associated with the UE’s PDU session(s).

N1, N2, N3, N4, N6, N9, N11, N14 may also be called reference points as defined in TS 23.501.

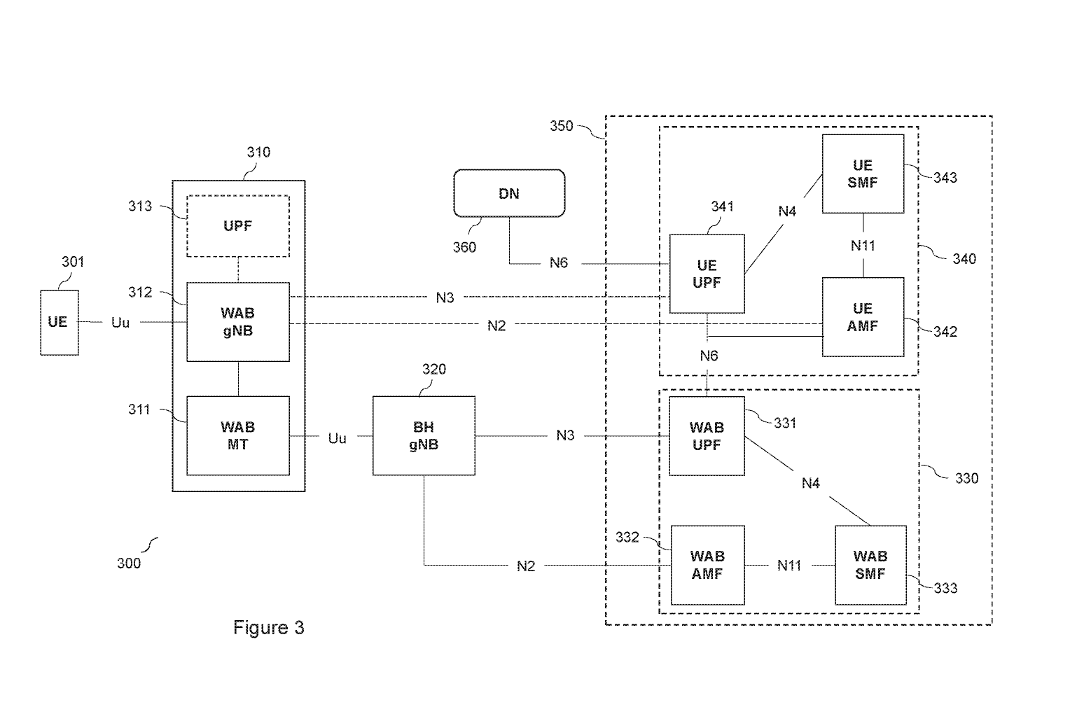

FIG. 3 is a simplified schematic diagram of a 5G system 300 involving a Wireless Access Backhaul (WAB) node (or a MWAB node), and in which the present invention may be implemented according to one or more example embodiments. This figure first represents a User Equipment (UE) 301 served by a WAB node 310 through the Uu interface. The WAB node 310 is composed of or includes a MT or WAB-MT or MWAB-MT unit/component/entity 311 (also called WAB-UE), and a gNB or WAB-gNB, or MWAB-gNB unit/component/entity 312. Through the WAB-gNB 312, a WAB node acts as a gNB for UEs providing access to the 5G network, i.e. providing a NR access link to the UEs that can be located inside or outside the entity, such as a vehicle, equipped with the WAB node 310 (e.g. on entering/leaving the vehicle). In other words, the WAB-gNB 312 includes full base station or gNB function (including both Central Unit (CU) and distributed unit (DU)) and MT function, where the gNB function is used to communicate with UEs for access service and the MT function is used to communicate with another gNB for backhauling purpose. The WAB node 310 wirelessly connects to the 5G Core Network (using NR Uu interface) through an IP connectivity provided by PDU session(s) established by the WAB-MT 311 via a gNB 320, which can be called a backhaul RAN node, BH RAN node, backhaul base station, backhaul gNB or BH gNB. Acting as a legacy UE, the WAB-MT 311 connects via a NG-RAN cell of the BH gNB 320, through a backhaul link (e.g. a wireless backhaul link) that may be a direct link or via a satellite (e.g. when the WAB node 310 is embedded in an airplane). Thus, a PDU session is provided either by a Terrestrial Network (TN) or by a Non-Terrestrial Network (NTN). In addition, the WAB node 310 may embed some core network functions, like a UPF 313, to enable local services to the served UEs. The traffic associated to these local services does not need to use the links to/from the core network via the BH gNB 320, which has the advantages to reduce the load on these links and to run applications having very low latency requirements. For example, where the WAB node 310 includes a UPF 313, the WAB node can connect to one or more local servers (e.g. mounted at the same entity as the WAB 310) enabling a UE served by the WAB access to local services provided by the local servers with no traffic required outside of the WAB node/server environment.

The BH gNB 320 provides N3 and N2 interfaces so that the WAB-MT 311 can access the functions of its 5G core network 330 (or backhaul 5GC or BH 5GC). Indeed, a WAB-MT 311 may have access to some or several PLMNs through the appropriate subscriptions, and it may connect in a non-roaming manner to one PLMN, e.g. PLMN1 supported by the BH gNB 320, and may then have access to the corresponding 5G core network 330. In particular the WAB-MT 311 interacts with the AMF 332, which can be called the WAB AMF or backhaul AMF or BH AMF, and establishes PDU session(s) with the UPF 331, which can be called the WAB UPF or backhaul UPF or BH UPF. The WAB UPF 331 is controlled by the SMF 333 (through N4 interface), which can be called the WAB SMF or backhaul SMF of BH SMF, and which also interacts with the WAB AMF 332 (through N11 interface). There may be one or several intermediate UPFs between the BH gNB 320 and the WAB UPF 331 as mentioned in the FIG. 2.

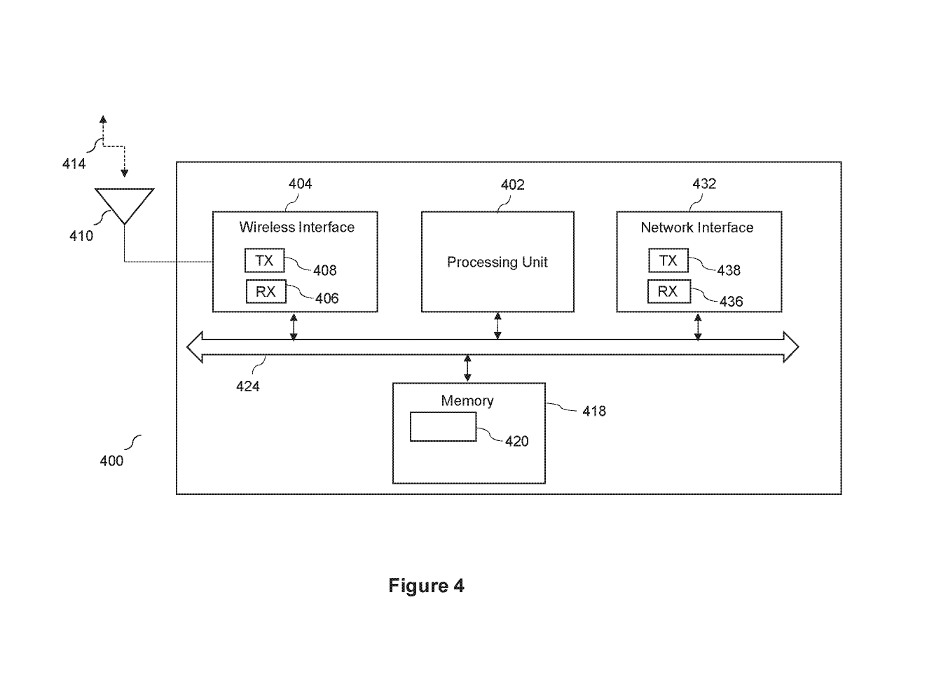

An interface internal to the WAB node 310 exists between the WAB-gNB 312 and the WAB-MT 311, which may be implemented on different or the same hardware resources. For instance, these two functions are implemented on the same processing unit 402 of FIG. 4, and interactions exist between the two functions.

Once the WAB-MT 311 has established a PDU session with the WAB UPF 331, the WAB node is ready to serve UEs and the WAB-gNB 312 can start operating as a legacy gNB. The WAB-gNB may support various PLMNs and the UE 301 connects to one PLMN, e.g. PLMN2, which may be different from the PLMN1 the WAB-MT 311 connects to. In the case where PLMN1 and PLMN2 are different, the UE 301 connects to the 5G core network 340 (or UE 5GC), including a UPF 341, which can be called the UE UPF, an AMF 342, which can be called the UE AMF, and a SMF 343, which can be called the UE SMF. The UE SMF 343 interacts with the UE AMF 342 (through N11 interface) and the UE UPF 341 (through N4 interface). In the case where the PLMN1 and the PLMN2 are the same, the UE UPF 341, the UE AMF 342, the UE SMF 343, the WAB UPF 331, the WAB AMF 332, and the WAB SMF 333 belong to the same 5G core network 350. In addition, the UE UPF 341 and the WAB UPF 331 may be the same UPF, the UE AMF342 and the WAB AMF 332 may be the same AMF, the UE SMF 343 and the WAB SMF 333 may be the same SMF.

DThe connections between the UE 301 to the UE UPF 341 and to the UE AMF 342 are possible thanks to the N6 interface between the UE UPF 341 and the WAB UPF 331, and thanks to the N6 interface between the WAB UPF 331 and the UE AMF 342. These N6 interfaces enable the establishment of N2 interface between the WAB-gNB 312 and the UE AMF 342, and the establishment of N3 interface between the WAB-gNB 312 and the UE UPF 341, which allows the UE 301 to access the Data Network 360.

In case the WAB-MT 311 connects to the 5G network in a roaming manner corresponding to the home routed option, then the PLMN1 is the visited PLMN and the WAB UPF 331 connects to another UPF not represented in the FIG. 3 in the home PLMN through a N9 interface. It is this other UPF that provides the connection to the UE UPF 341 and the UE AMF 342 through N6 interfaces.

In case the WAB-MT 311 connects to the 5G network in a roaming manner corresponding to the local breakout option, then the PLMN1 is the visited PLMN and the WAB UPF 331 directly connects to the UE UPF 341 and the UE AMF 342 through N6 interfaces as shown in the FIG. 3.

FIG. 4 is a block schematic diagram of an example network node or RAN node or base station 400, such as base stations or gNBs or WAB nodes shown in FIG. 1, in accordance with one or more embodiments of the invention. Each of a WAB node 110, 120a, 120b, 130, 140, or 150 of FIG. 1 may comprise the elements of the base station of FIG. 4. Also, the satellite 160 of FIG. 1 may comprise the elements of the base station of FIG. 4. In the following description, the network node 400 will be referred to generally as a base station. As will be apparent to a skilled person, FIG. 4 is a simplified schematic diagram and shows only some of the functional components of an example base station 400 for use in describing the one or more embodiments of the invention.

The base station 400 includes components for transmitting and receiving communications. As shown in FIG. 4, the base station 400 includes a processing unit 402, a wireless interface 404, one or more antennas 410, a network interface 432, and memory 418.

The network interface 432 manages communications of the base station 400 with the core network, other base stations, local network functions (like UPF), or local servers. It may provide a standardized interface, wired (e.g. fiber) or wireless, to support these communications. Through this network interface 432, the base station 400 may implement the standardized interfaces N2 (based on NGAP protocol) and N3 (based on GPRS tunneling protocol) with the core network, and the standardized interface Xn (based on XnAP protocol) with other base station of the Radio Access Network (RAN), all defined by the 3GPP standard. The networkinterface 432 may not be present or active in case the base station 400 is a WAB node that does not support local services, that is not used as a legacy base station like base station 102, 104 in FIG. 1, and that is not used as a home base station providing Femto cells like base station 130 in FIG. 1.

The wireless interface 404 is configured to provide wireless communication via communication links (414) with other wireless devices, such as one or more UEs, e.g. link D1041b between base station 104 and the MT/UE unit of WAB node 120b, or link D1202 between the gNB unit of WAB node 120b and the UE 122. In case of WAB node, the wireless interface 404 may then be used both for the wireless backhaul link(s) with backhaul base station(s) and for the wireless link(s) with the UE(s) served by the WAB node. The wireless interface 404 may be compliant with a fifth-generation (5G) New Radio (NR) system and thus implementing the Uu interface defined by 3GPP standard, or with other wireless communication system. The wireless interface 404 is coupled to the processing unit 402 and to one or more antennas (such as the antenna 410). The wireless interface 404 typically includes a receiving unit 406 and a transmitting unit 408. The configuration of the wireless interface 404 may be limited to connect to one antenna, but preferably several antennas are used, in order to provide beamforming capability. Although not shown in FIG. 4, the receiving unit 406 typically includes elements such as a receiver, demodulator, decoder, and the transmitting unit 408 typically includes elements such as a transmitter, modulator, coder. The receiving unit 406 and transmitting unit 408 may together be referred to as a transceiver.

The processing unit 402 is configured to carrying out processing for operation of the base station 400. The processing unit 402 may be a single processor (e.g. Central Processing Unit) or may comprise two or more processors. The number of processors and the allocation of processing functions to the processors is a matter of design choice for a skilled person. The base station 400 includes memory 418 for storing data and computer programs containing instructions for the operation of the base station 400. Memory 418 includes RAM (Random Access Memory), ROM (Read Only Memory), or combination of both or as a non-limiting example a mass storage device such as a disk or a Solid-State Drive. Memory 418 includes a program memory in which are stored programs containing processor instructions for operation of the base station 400 and for implementing the methods in accordance with one or more embodiments of the invention. The programs may contain a number of different program elements or sub-routines (represented by element 420 in memory 418) containing processor instructions for a variety of different tasks, for example, the resource coordination with another base station. Memory 418 may further include memory (e.g. RAM) for storing information such as identifiers of network devices.

The operation of the program elements or sub-routines 420 will be described in more detail below.

In an example arrangement, a communication bus 424 provides communication and interoperability between the various elements included in the base station 400 or connected to it. The representation of the bus is not limiting and in particular, the processing unit 402 is operable to communicate instructions to any element of the base station 400 directly or by means of another element of the base station 400.

In an example implementation, the base station 400 may be or may include an apparatus comprising one or more processing units or processors for performing or implementing the methods in accordance with one or more embodiments of the invention. In other words, the apparatus is capable of performing one or more functions of the base station including performing the methods in accordance with one or more embodiments of the invention by means of the one or more processing units. For example, the one or more processing units uses software to implement the one or more embodiments of the invention as described above with reference to the processing unit 402 of FIG. 4. Instructions may be executed by one or more processors, such as one or more digital signal processors (DSPs), general purpose microprocessors, a CPU of a microcontroller Unit (MCU), application specific integrated circuits (ASICs), field programmable gate arrays (FPGAs), or other equivalent integrated (e.g. on an Integrated Circuit) or discrete logic circuitry. However, alternatively, the one or more processing units for performing or implementing the methods may be implemented in hardware: for example, in the form of an Application Specific Integrated Circuit or ASIC or other hardware comprising logic element (s). Accordingly, the term “processing unit” as used herein may refer to any of the foregoing structure or any other structure suitable for implementation of the techniques described herein.

In a 5G core network, an AMF (Access and Mobility management Function) like the WAB AMF 332 or the UE AMF 342, may be implemented with the apparatus described in the FIG. 4 where the Wireless Interface 404 and the antenna 410 is not present.

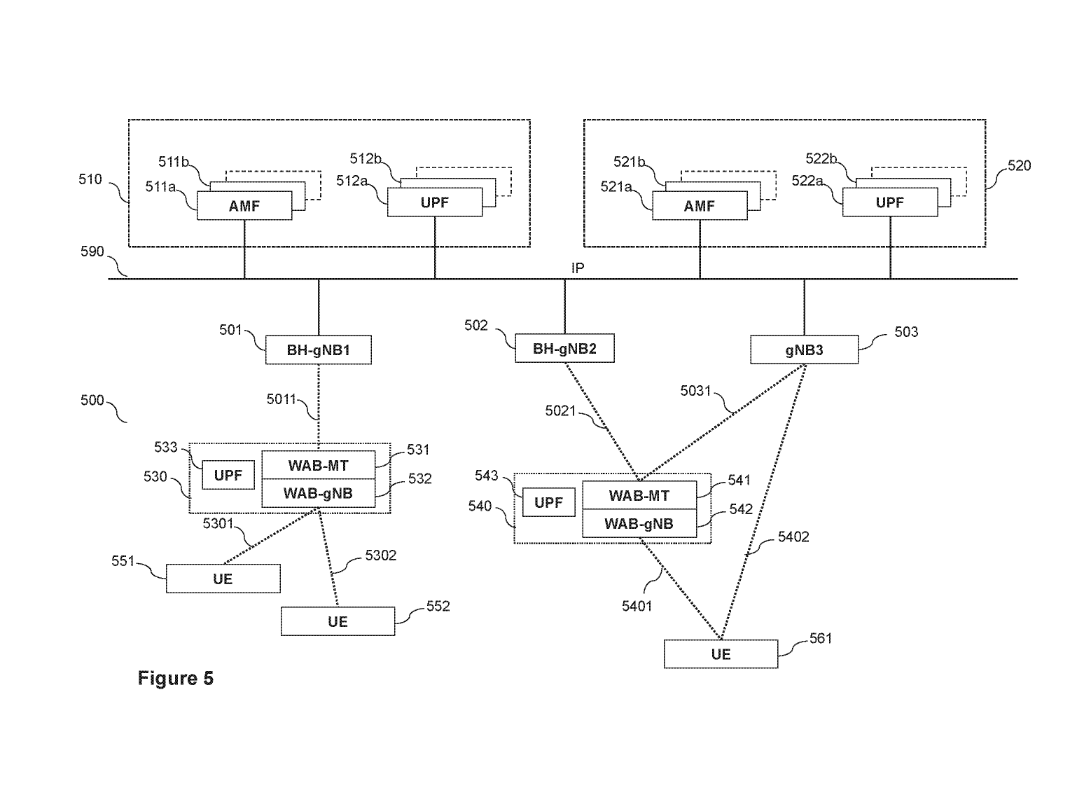

FIG. 5 illustrates an example of a wireless communication system 500, including a WAB network or WAB network system, in which embodiments and examples of embodiments of the present invention may be implemented.

A WAB network will also be referred to as a WAB network system, WAB topology, WAB system, topology or system and so in this application, the terms WAB network system, WAB network, WAB topology, WAB system, topology or system will be used interchangeably.

The WAB network system of FIG. 5, is composed of three base stations (or NG-RAN nodes or gNBs) 501, 502 and 503, two 5G core networks 510 and 520, with the respective AMF entities 511a and 511b (for Core Network 510) and 521a and 521b (for Core Network 520) and the respective UPF entities 512a and 512b (for Core Network 510) and 522a and 522b (for Core Network 520), and two WAB nodes 530 and 540.

When a base station serves a WAB node, it can also be referred to as a backhaul base station or backhaul RAN node (also referred to as BH RAN node or BH-RAN node, BH-RAN-node), or backhaul gNB (also referred to as BH-gNB).

A wired backhaul IP network 590 interconnects the base stations 501, 502 and 503 and the Core Networks 510 and 520. For instance, this wired link consists of optical fiber cable(s).

As discussed above, each WAB node comprises a Mobile Termination (MT) component or part or unit (WAB-MT 531 for WAB node 530 and WAB-MT 541 for WAB node 540) and a RAN node or base station or gNB component or part or unit (WAB-gNB 532 for WAB node 530 and WAB-gNB 542 for WAB node 540).

WAB node 530 and WAB node 540 may also embed a UPF entity, respectively UPF entity 533 and UPF 543, as previously discussed in FIG. 3, allowing WAB-node 530 to provide UEs 551, 552 and 561 with some local services, such as for instance inter-UE communication where the use5r data exchanged between the two UEs would be routed through UPF entity 533/543 instead of being routed through a UPF entity belonging to Core Network 510 or 520.

WAB node 530 is connected to the serving backhaul base station referred to as BH-gNB1, 501 through the wireless backhaul (BH) link 5011.

WAB node 540 is connected to the serving backhaul base station referred to as BH-gNB2, 502 through the wireless backhaul (BH) link 5021.

WAB-gNB 532 of WAB node 530 serves UE 551 through communication link or radio link 5301, and UE 552 through communication link or radio link 5302.

Similarly, WAB-gNB 542 of WAB node 540 serves UE 561 through communication link or radio link 5401.

Although FIG. 5 shows only UE 561 connected to WAB node 540, it will be appreciated that there will be a plurality of UEs connected to WAB nodes of the wireless communication system.

WAB-gNB 532 and WAB-MT 531 may be connected to a same AMF function or entity (e.g., AMF 511a) or to different AMF functions or entities belonging to the same Core Network (e.g., AMF 511a and AMF 511b) or to different Core Network (e.g., AMF 511a and AMF 521a).

Some AMF functions may be implementing WAB-specific features for managing a WAB node (e.g., advanced mobility features). Some AMF functions may not implement such features but may still be capable of serving a WAB node with a limited set of basic features. Some AMF functions may not be capable of serving a WAB node.

Also, a base station (or gNB) may be enhanced with WAB support or WAB capability. This means that the base station is aware of the existence of WAB nodes, and can adapt its behaviour to optimize the operation at WAB nodes. In other words, a gNB with WAB support or WAB capability is a gNB that can adapt its behaviour to optimize the operation at WAB nodes. In particular, a WAB aware base station is able to perform WAB resource coordination, when necessary, in order to avoid or to minimize radio interferences that may arise because of the presence of a WAB node in the same geographical area.

Taking the example of FIG. 5, the frequency bands used for the cell(s) controlled by the WAB-gNB 542 to serve UEs (like UE 561 with the access link 5401) may be the same as the frequency bands used for the cell(s) controlled by the BH-gNB2 542 to serve UEs or WAB-MTs (like WAB-MT 541 with the backhaul link 5021). This situation may be referred to as a WAB in-band scenario (or in-band scenario), which may lead to radio interferences. For instance, if the BH-gNB2 502 starts transmitting data to the WAB-MT 541 or in the direction of the WAB-MT 541, while the UE 561 is transmitting data to the WAB-gNB 542, both the WAB-MT 541 and the co-located WAB-gNB 542 may be unable to decode the received radio signals. Therefore, radio resource coordination is required to avoid or to minimize such radio interferences with this WAB in-band scenario.

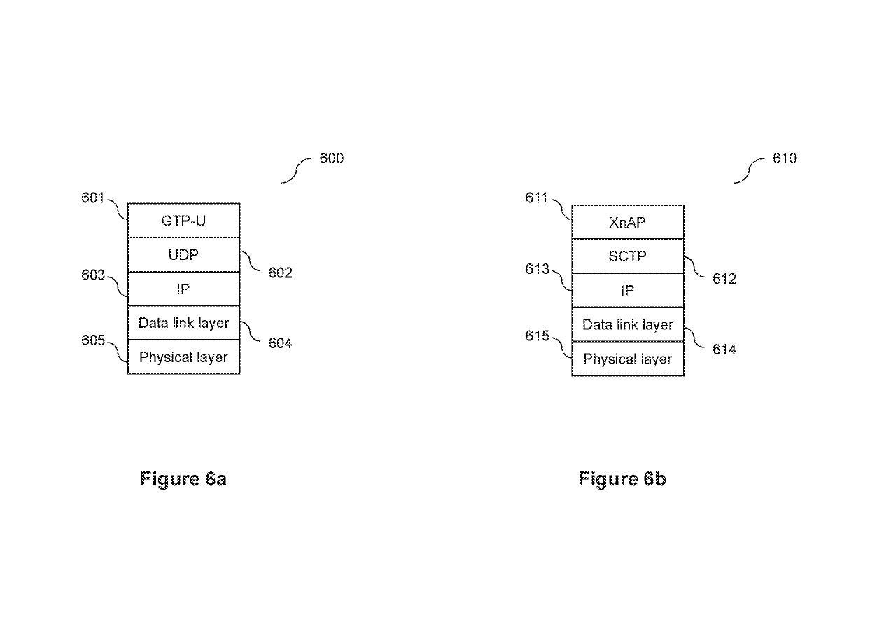

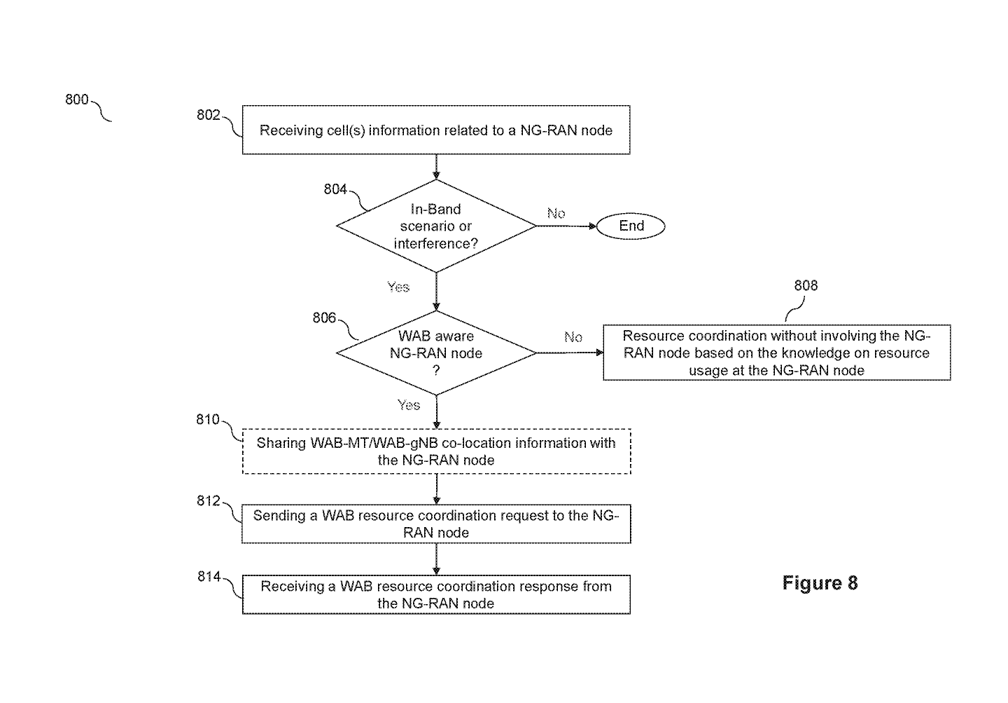

When the backhaul BH-gNB2 502 is not WAB aware (i.e. the WAB-MT 541 is seen as a legacy UE), resource coordination involving both the BH-gNB2 502 and the WAB-gNB 542 is not possible. In that case, and as described in the method of FIG. 8, the WAB-gNB 542 has to adapt its radio resource usage alone, based on information related to the BH-gNB2’s cell(s) it can obtain, using, for instance, the Automatic Neighbour Cell Relation Function described in TS 38.300 section 15.3.3. Indeed, some useful information can be obtained at the WAB-gNB 542 from measurement reports from the served UEs (like UE 561) and/or from the WAB-MT 541, and from neighbour cell information that can be shared between NG-RAN nodes using Xn procedures (e.g. Xn Setup, or NG-RAN node Configuration Update procedures mentioned in the description of the FIG. 6).

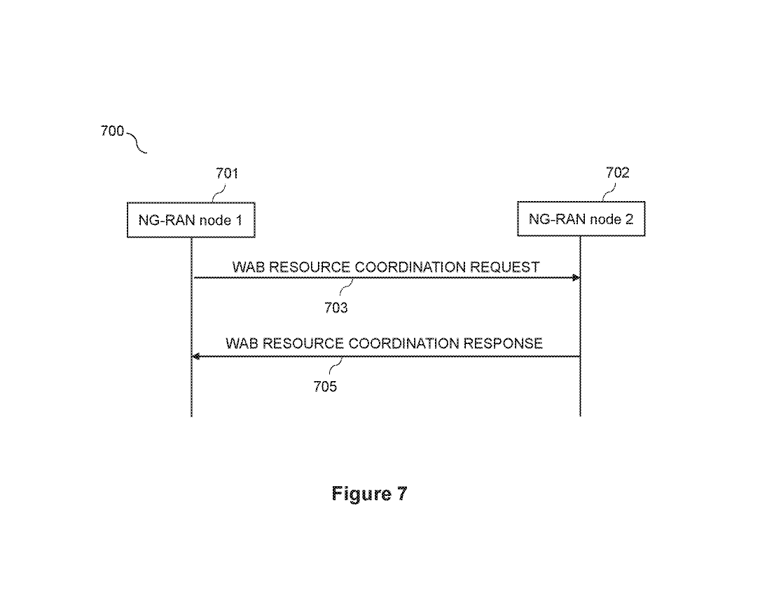

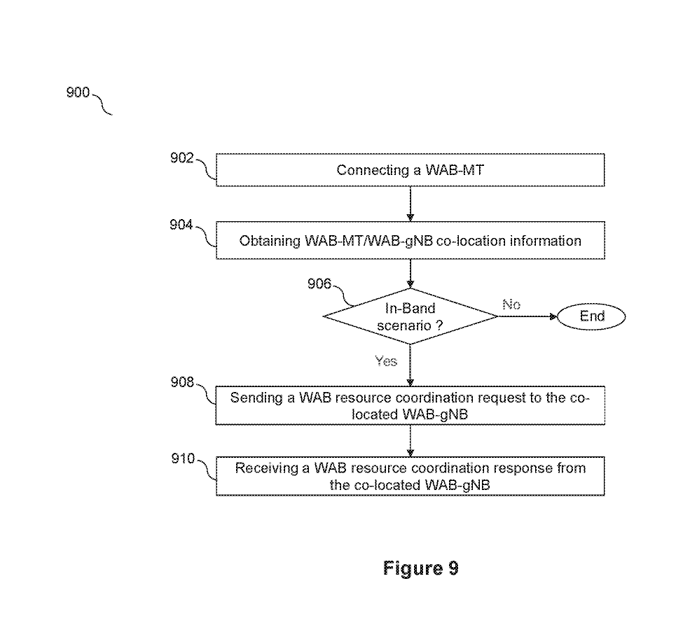

When the backhaul BH-gNB2 502 is WAB aware, WAB resource coordination involving both the BH-gNB2 502 and the WAB-gNB 542 is feasible. Information related to the usage of radio resources can be shared between the BH-gNB2 502 and the WAB-gNB 542, using the method described at the FIGS. 8 and 9, with the procedure described at the FIG. 7. Both BH-gNB2 502 and the WAB-gNB 542 can then adapt the usage of their radio resources to avoid or to minimize radio interference (that is, they can perform resource coordination). For instance, the WAB-gNB 542 can avoid scheduling transmissions from the UEs it serves when the BH-gNB2 502plans transmissions to the WAB-MT 541.

Still based on the example of FIG. 5, several scenarios are possible according to the mobility of WAB nodes 530 and 540.

As a first scenario, and taking the example of WAB node 540, a dual-connectivity configuration may be applied to the WAB-MT 541, initially connected to BH-gNB2 502 only through the link 5021. Indeed, the WAB-MT 541 periodically performs a cell search procedure, as defined in 3GPP TS 38.300, trying to detect a PSS (Primary Synchronization Signal) and a SSS (Secondary Synchronization Signal). The WAB-node may report to BH-gNB2 502 the presence of a new cell, for instance one cell managed by the gNB3 503, through a measurement report. Based on the analysis of the measurement report, the BH-gNB2 502 may request to the gNB3 503 the establishment of a dual connectivity for the WAB-MT 541 with an additional connection through the link 5031. The gNB3 503 may accept the request and proceed with the connection of the WAB-MT 541 according to the procedure described in TS 37.340 section 10.2.2. As a result, the WAB-MT 541, and thus the WAB node 540 is dual-connected. In this configuration, the BH-gNB2 502 is the Master Node (MN), and gNB3 is the Secondary Node (SN). The BH-gNB2 502 may take benefit of the dual connectivity of WAB node 540 to balance the traffic load by offloading some traffic (data/user traffic or control traffic) initially planned to be transmitted through the link 5021. Some or all the traffic associated to the WAB node 540 (i.e. control data related to the WAB node, and control and user data related to the UEs served by the WAB node 540) may be transmitted through the link 5031 and through the Xn interface between BH-gNB2 502 and gNB3 503. Dual-connectivity may also be used to increase the reliability of communications between the WAB-MT 541 and the BH-gNB2 502 through duplication (i.e. redundancy). For instance, the same data are transmitted twice: one direct transmission through the link 5021 and one indirect transmission using the link 5031 and gNB3 503 as a relay.

Assuming BH-gNB2 502 and gNB3 503 are terrestrial and stationary base stations, the allocation of frequency bands used by these two base stations should take into account the stable position of these base stations, and the geographical proximity of these two base stations. Thus, the frequency bands used by BH-gNB2 502 should be different from the frequency bands used by gNB3 503, and no radio interference are expected where the radio coverage of cells controlled by these bases stations overlaps geographically. However, when the WAB-MT 541 is connected to the BH-gNB2 502, it may also be in a geographical area covered by a cell controlled by the gNB3 503. Then, in case of WAB in-band scenario with the gNB3 503, when the frequency bands used by the WAB-gNB 542 are the same as the ones used by gNB3 503, radio interference may happen in the geographical area where the radio coverage of cells of WAB-gNB 542 and gNB3 503 overlaps. When gNB3 503 is not WAB aware (i.e. the WAB-MT 541 is seen as a legacy UE), resource coordination involving both the gNB3 503 and the WAB-gNB 542 is not possible. In that case, the WAB-gNB 542 has to adapt its radio resource usage alone, based on information related to the gNB3’s cell(s) it can obtain, using, for instance, the Automatic Neighbour Cell Relation Function described in TS 38.300 section 15.3.3. When gNB3 503 is WAB aware, WAB resource coordination involving both the gNB3 503 and the WAB-gNB 542 is feasible. Information related to the usage of radio resources can be shared between the gNB3 503 and the WAB-gNB 542, using the procedure described at the FIG. 7. Both gNB3 503 and WAB-gNB 542 can then adapt the usage of their radio resources to avoid or to minimize radio interference. It is also beneficial to setup this resource coordination as soon as possible, in parallel of the execution of the procedure to setup dual-connectivity. It can also be observed that dual-connectivity also involves some resource coordination as described in TS 37.340 section 7.9, thus the gNB3 503 may have to simultaneously handle resource coordination with WAB-gNB 542 on one hand, and with BH-gNB2 502 on the other hand.

As a second scenario, the radio link 5021 may experience radio link deficiency due to some unexpected interference or shadowing phenomena. For such reasons, the WAB-MT 541 may lose the connection with the BH-gNB2 502 and declare a Radio Link Failure (RLF). Then, the WAB-MT 541 will try to re-establish the connection in the same or a different cell controlled by BH gNB2 502 or by another gNB. Thus, the WAB-MT 541 may try to connect to a cell controlled by gNB3 503 by requesting the establishment of the link 5031. In this case, the reestablishment procedure described in TS 38.300 section 9.2.3.3 may be applied, which enables a UE to maintain the RRC connection. With such procedure, the gNB3 503 sends to the BH gNB2 502 a request to retrieve the context of the WAB-MT 541. Based on the response from the BH gNB2 502, the gNB3 503 may accept the connection of the WAB-MT 541. Then, all the traffic related to the WAB node 540 (and the served UEs) will now transit through the gNB 503, which becomes the backhaul gNB for the WAB node 540. The reestablishment procedure does not involve the WAB-gNB 542 and its served UEs. In case of WAB in-band scenario between WAB-gNB 542 and gNB3 503, WAB resource coordination can be applied, by the WAB-gNB 542 alone or with the procedure described at the FIG. 7 when gNB3 503 is WAB aware.

As a third scenario, the WAB-MT 541 may be handed over from the current serving cell to a new cell. Indeed, based on the measurement reports provided by the WAB-MT 541, the BH-gNB2 502 may detect that the WAB-MT 541 would have a better connection through a cell managed by the gNB3 503. Then, the BH-gNB2 502 may trigger a handover procedure described in TS 38.300 section 9.2.3.2. In this procedure, the BH-gNB2 502 sends a handover request to the gNB3 503 along with information related to the WAB-MT 541. Based on this information, the gNB3 503 may accept the handover request and proceed to the admission of the WAB-MT 541. Then, all the traffic related to the WAB node 540 (and the served UEs) will now transit through the gNB3 503, which becomes the backhaul gNB for the WAB node 540. In case of WAB in-band scenario with the gNB3 503, WAB resource coordination is necessary. When gNB3 503 is not WAB aware (i.e. the WAB-MT 541 is seen as a legacy UE), resource coordination involving both the gNB3 503 and the WAB-gNB 542 is not possible. In that case, the WAB-gNB 542 has to adapt its radio resource usage alone, based on information related to the gNB3’s cell(s) it can obtain, using, for instance, the Automatic Neighbour Cell Relation Function described in TS 38.300 section 15.3.3. When gNB3 503 is WAB aware, WAB resource coordination involving both the gNB3 503 and the WAB-gNB 542 is feasible. Information related to the usage of radio resources can be shared between the gNB3 503 and the WAB-gNB 542, using the procedure described at the FIG. 7. Both gNB3 503 and WAB-gNB 542 can then adapt the usage of their radio resources to avoid or to minimize radio interference. It is also beneficial to setup this resource coordination as soon as possible, in parallel of the execution of the handover procedure.

As a fourth scenario, the WAB node 540 may not move fast or may be stationary for some time, and the WAB-MT 541 remains connected to the BH-gNB2 502 only. Still, the WAB-MT 541, and thus the co-located WAB-gNB 542 may be in a geographical area also covered by a cell controlled by a neighbour NG-RAN node, for instance gNB3 503 and/or WAB-gNB 532. Then, in case of the frequency bands used by the WAB-gNB 542 and the frequency bands used by the gNB3 503 and/or WAB-gNB 532 are the same, radio interference may happen, and radio resource coordination is necessary. This situation may not be considered as a WAB in-band scenario (as there is no backhaul link involved) but the procedure of FIG. 7 may be applied when WAB-gNB 532 is involved or when gNB3 503 is involved and is WAB aware. It may happen that WAB-gNB 542 has to simultaneously manage resource coordination with gNB3 503 on one hand, and with WAB-gNB 532 on the other hand.

Lastly, it can be considered the case of a dual-connected UE involving a WAB node. For instance, the UE 561 may be dual-connected with a connection with WAB-gNB 542 through the link 5401 and a connection with gNB3 503 through the link 5402. One can observe that it is not beneficial that the WAB-gNB 542 is the Master Node (MN) for the dual-connectivity. Indeed, in this configuration some data to/from the UE 561 have to be transmitted twice on the backhaul link 5021 (assuming the co-located WAB-MT 541 is served by BH-gNB2 502). In downlink, the data to be transmitted to the UE 561 come from a 5G core network (for instance the core network 510), they arrive at the WAB-gNB 542 through the backhaul link 521. Then, some data are directly transmitted by the WAB-gNB542 to the UE 561 while the same or other data will be transmitted to the UE 561 by gNB3 503. The data to be transmitted by gNB3 503 are provided by the WAB-gNB 542, thus they transit again through the backhaul link 5021 and through BH-gNB2 502. These two transmissions other the backhaul link 5021 increase the transmission latency up to the UE 561 and it annuls the interest of increasing bandwidth with dual-connectivity. The issue is the same for uplink data sent by the UE 561 to the 5G core network. When the WAB-gNB 542 is Secondary Node (SN) for dual-connectivity of the UE 561 with gNB3 as Master Node, the data to/from the UE 561 transiting by the WAB-gNB 542 are transmitted only once over the backhaul link 5021. As a result, a WAB-gNB should refrain from initiating dual-connectivity for a served UE (i.e. it should refrain being the Master Node for dual-connectivity of a served UE). It can also be noted that dual-connectivity may involve some resource coordination as described in TS 37.340 section 7.9. When the WAB-gNB 542 is Secondary Node for dual-connectivity of a served UE, it may happen that WAB-gNB 542 has to simultaneously manage resource coordination with the backhaul base station serving the co-located WAB-MT 541 (i.e. BH-gNB2 502) on one hand, and with the Master Node (i.e. gNB3 503) for dual-connectivity of a UE on the other hand.

FIG. 6a is a schematic diagram 600 illustrating the protocol stack associated to the Xn interface in the user plane, referred to as Xn-U. The Xn-U interface and the associated TNL protocol stack are described in the following 3GPP specifications: TS 38.420, TS 38.421, TS 38.424

The Xn user plane interface (Xn-U) is defined between two NG-RAN nodes, and is built on IP (Internet Protocol) transport. GTP-U (GPRS (General Packet Radio Service) Tunnelling Protocol for User Plane) 601 is used on top of UDP (User Datagram Protocol) 602 and IP 603 to carry the user plane PDUs between two NG-RAN nodes.

GTP-U 601 is defined in TS 29.281, while UDP 602 is defined in IETF RFC 768, and IP 603 is defined in IETF RFC 8200 (for IPv6) and IETF RFC 791 (for IPv4).

Any data link layer 604 and physical layer 605 that fulfil the requirements toward the upper layers 601, 602, 603 may be used. For instance, they can be implemented with Ethernet protocol over fiber cables.

FIG. 6b is a schematic diagram 610 illustrating the protocol stack associated to the Xn interface in the control plane, referred to as Xn-C. The Xn-C interface and the associated TNL protocol stack are described in the following 3GPP specifications: TS 38.420, TS 38.421, TS 38.422, TS 38.423.

The Xn control plane interface (Xn-C) is defined between two NG-RAN nodes, and it is built on IP (Internet Protocol) transport. XnAP (Xn Application Protocol) 611 is used on top of SCTP (Stream Control Transmission Protocol) 612 and IP 613 to carry the control plane data between two NG-RAN nodes.

XnAP 611 is defined in TS 38.423, while SCTP 612 is defined in IETF RFC 4960, IP 603 is defined in IETF RFC 8200 (for IPv6) and IETF RFC 791 (for IPv4).

Any data link layer 614 and physical layer 615 that fulfil the requirements toward the upper layers 611, 612, 613 may be used. For instance, they can be implemented with Ethernet protocol over fiber cables.

Details of example XnAP procedures are set out in section 8 of TS 38.423, V.18.3.0. XnAP procedures may also be referred to as Xn protocol procedures or signalling procedures of Xn application protocol.

In particular, the Xn Setup procedure (described in TS 38.423 section 8.4.1) enables the establishment of a Xn interface between two NG-RAN nodes (like WAB-gNB 542 and gNB3 503).

The NG-RAN node Configuration Update procedure (described in TS 38.423 section 8.4.2) enables a NG-RAN node to provide updated configuration data to another NG-RAN node.

The Handover Preparation procedure (described in TS 38.423 section 8.2.1) is used to establish necessary resources in a target NG-RAN node, for the handover of a UE (or a MT component of a WAB node) served by a source NG-RAN node initiating the procedure. For instance, this procedure may be applied between BH-gNB2 502 and gNB3 503 to handover the WAB-MT 541 from a cell controlled by BH-gNB2 502 to a cell controlled by gNB3 503.

The S-NG-RAN node Addition Preparation procedure (described in TS 38.423 section 8.3.1) is used to request a secondary NG-RAN node to allocate resources, for dual connectivity operation for a UE (or a MT component of a WAB node) served by a master NG-RAN node initiating the procedure. This procedure may be applied between BH-gNB2 502 and gNB3 503 to setup dual-connectivity at the WAB-MT 541.

The Xn Removal procedure (described in TS 38.423 section 8.4.6) enables the removal of a Xn interface between two NG-RAN nodes (like WAB-gNB 542 and gNB3 503).

The WAB Resource Coordination procedure to coordinate radio resource usage between two NG-RAN nodes (one being a WAB-gNB), as described with the FIG. 7.

FIG. 7 is a schematic diagram 700 showing first example message flows for managing WAB resource coordination between the gNB component of a WAB node and a WAB aware NG-RAN node. This figure shows two WAB aware NG-RAN nodes 701 and 702, referred to as NG-RAN node 1 and NG-RAN 2 respectively. NG-RAN node 1 may be the gNB component of a WAB node (i.e. a WAB-gNB), while NG-RAN node 2 may be a backhaul RAN node serving the MT component co-located with NG-RAN node 1 (i.e. the WAB-MT), or the target NG-RAN node for the handover of this WAB-MT, or the secondary node for dual-connectivity of this WAB-MT, or any NG-RAN node having no communication with this WAB-MT. Similarly, NG-RAN node 2 may be the gNB component of a WAB node (i.e. a WAB-gNB), while NG-RAN node 1 may be the backhaul RAN node serving the MT component of the WAB node (i.e. the WAB-MT co-located with NG-RAN node 1), or the target NG-RAN node for the handover of this WAB-MT, or the secondary node for dual-connectivity of this WAB-MT, or any NG-RAN node having no communication with this WAB-MT.

The two messages WAB RESOURCE COORDINATION REQUEST message 703 and WAB RESOURCE COORDINATION RESPONSE message 705 are transmitted during a procedure for WAB resource coordination involving at least one WAB-gNB (NG-RAN node 1 and/or NG-RAN node 2). This procedure may be applied when a WAB in-band scenario is detected or when radio interference may happen between at least two cells, one cell being controlled by NG-RAN node 1 and the other cell being controlled by NG-RAN node 2.

NG-RAN node 1 sends the message 703 to the NG-RAN node 2, and the NG-RAN node 2 responds to the NG-RAN node 1 with the message 705.

The message 703 may include at least one of the following information elements:
Message Type, as defined in TS 38.423 section 9.2.3.1, for instance with the value “Initiating Message”;
An identifier of the NG-RAN node 1, for instance the Global RAN Node ID as defined in TS 38.423 section 9.2.2.3, as the identifier of the transmitter or sender of the message 703;
An identifier of a WAB-MT co-located with NG-RAN node 1 in a WAB node when NG-RAN node 1 is a WAB-gNB. Where the message 703 comprises this identifier, this enables this identifier to be provided to the NG-RAN node 2. It may be a Cell Radio Network Temporary Identifier (C-RNTI as defined in TS 38.300) allocated by the NG-RAN node 2, or a NG-RAN node UE XnAP ID (defined in TS 38.423 section 9.2.3.16) allocated by the NG-RAN node 2;
A resource coordination status, which indicates whether the resource coordination has to be started, or continued, or suspended or resumed, or stopped;
Cause information, which indicates the cause of the message 703. For instance the cause value may be “handover” or “dual-connectivity” when resource coordination is started (i.e. this the first message); “update” when update information is provided, or “low risk” when resource coordination can be stopped (as it is no longer required). Where the value of the cause information is “handover”, the cause information may indicate to the NG-RAN node 2 that the reason for initiating the resource co-ordination is due to handover of the WAB-MT. Where the value of the cause information is “dual-connectivity”, the cause information may indicate to the NG-RAN node 2 that the reason for initiating the resource co-ordination is to configure dual-connectivity of the WAB-MT. Indicating the reason for initiating the resource co-ordination to the NG-RAN node 2 in this manner may therefore prevent the NG-RAN node 2 rejecting the request for resource co-ordination.
Radio resource usage at the NG-RAN node 1, with at least one of the following fields for each cell controlled by the NG-RAN node 1:
   NR Frequency information as defined in TS 38.423 section 9.2.2.19;
   Used slot format with the type of symbols (Downlink, Uplink, Flexible) as defined in Table 11.1.1-1 of TS 38.213;
   Slots used for transmission to/from the co-located WAB-MT when NG-RAN node 1 is communicating with the WAB-MT co-located with NG-RAN node 2 in a WAB node when NG-RAN node 2 is a WAB-gNB;
   The list of slots that would be available for the NG-RAN node 2;
   Multiplexing capability when NG-RAN node 1 is a WAB-gNB, indicating whether simultaneous transmission and reception are possible between the WAB-gNB and the co-located WAB-MT (Rx/Rx, Tx/Tx, Tx/Rx, or Rx/Tx at WAB-MT/WAB-gNB);
   Configuration of specific signals used for synchronization, reference, or Random-Access Channel (RACH) procedure.

The message 705 may include at least one of the following information elements:
Message Type, as defined in TS 38.423 section 9.2.3.1, for instance with the value “Successful Outcome”;
An identifier of the NG-RAN node 2, for instance the Global RAN Node ID as defined in TS 38.423 section 9.2.2.3, as the identifier of the transmitter or sender of the message 705;
An identifier of a WAB-MT co-located with NG-RAN node 2 in a WAB node when NG-RAN node 2 is a WAB-gNB. Where the message 705 comprises this identifier, this enables this identifier to be provided to the NG-RAN node 1. It may be a Cell Radio Network Temporary Identifier (C-RNTI as defined in TS 38.300) allocated by the NG-RAN node 1, or a NG-RAN node UE XnAP ID (defined in TS 38.423 section 9.2.3.16) allocated by the NG-RAN node 1;
A resource coordination status, which indicates whether the resource coordination has to be started, or suspended or resumed, or stopped. The stop status may be used to reject a request for resource coordination received with the message 703;
Cause information, which indicates the cause of rejection if NG-RAN node 2 rejects the request received with the message 703. For example, the cause value may be “mobility” or “low risk”;
Radio resource usage at the NG-RAN node 2, with at least one of the following fields for each cell controlled by the NG-RAN node 2:
   NR Frequency information as defined in TS 38.423 section 9.2.2.19;
   Used slot format with the type of symbols (Downlink, Uplink, Flexible) as defined in Table 11.1.1-1 of TS 38.213;
   Slots used for transmission to/from the co-located WAB-MT when NG-RAN node 2 is communicating with the WAB-MT co-located with NG-RAN node 1 in a WAB node when NG-RAN node 1 is a WAB-gNB;
   The list of slots that would be available for the NG-RAN node 1;
   Multiplexing capability when NG-RAN node 2 is a WAB-gNB, indicating whether simultaneous transmission and reception are possible between the WAB-gNB and the co-located WAB-MT (Rx/Rx, Tx/Tx, Tx/Rx, or Rx/Tx at WAB-MT/WAB-gNB);
   Configuration of specific signals used for synchronization, reference, or Random-Access Channel (RACH) procedure.

Resource coordination performed according to this procedure may involve several exchanges of messages 703 and 705 between NG-RAN node 1 and NG-RAN node 2. As an example of a rule for resource coordination, when NG-RAN node 2 receives the message 703, it takes into account the content of the message 703 and may adapt the usage of its radio resources accordingly before sending the message 705 to the NG-RAN node 1. If a first NG-RAN node sends a message 703 to a second NG-RAN node and then receives a message 703 from the second NG-RAN node, it means that both NG-RAN nodes have sent a message 703 at approximately the same time. In this case, the NG-RAN nodes detecting this issue will abort the procedure 700, and they will make a new attempt later after waiting for a certain time.

FIG. 8 is a flowchart of an example method 800 for initiating WAB resource coordination at the gNB component of a WAB node, i.e. a WAB-gNB like WAB-gNB 542 of FIG. 5. The method may be performed by software elements and/or hardware elements. The network entity may be implemented in a network node 400 as shown in and described with reference to FIG. 4 with the method being performed by an apparatus for the network entity including one or more processing units, such as the processing unit 402.

At step 802, the WAB-gNB receives information related to cell(s) controlled by another NG-RAN node. This information may be received:
from UE(s) served by the WAB-gNB performing measurements on cell(s) in the neighbourhood and reading System Information Block 1 (SIB1) broadcasted in each cell,
from the co-located MT component of the WAB node (i.e. by the WAB-MT through an interface internal to the WAB node), performing measurements on cell(s) in the neighbourhood as other legacy UEs, and reading System Information Block 1 broadcasted in each cell (SIB1 content is described in TS 38.331).
from NG-RAN node(s) in the neighbourhood through an Xn interface (e.g. with NG-RAN node Configuration Update procedure).

The cell information provides NR frequency band(s) used in the cell and an identifier of the cell including an identity of the NG-RAN node controlling the cell.

This step 802 may include the execution of the Automatic Neighbour Cell Relation Function described in TS 38.300 section 15.3.3.

In this step 802, the WAB-gNB is also informed by the WAB-MT whether:
the WAB-MT is connecting to the NG-RAN node as a new backhaul NG-RAN node, i.e. a BH RAN node or BH-gNB like BH-gNB2 502 of FIG. 5,
the WAB-MT is being handed over to a reported cell, or
the WAB-MT is being dual-connected through a reported cell.

At step 804, the WAB-gNB checks whether radio interferences may happen with signals in the cell(s) reported at step 802, and whether a WAB in-band scenario is detected. This evaluation is performed by comparing the frequency band(s) the WAB-gNB uses to serve UEs with the frequency band(s) used in the reported cell(s). The WAB in-band scenario occurs when radio interferences may happen for a cell where the WAB-MT is connected to BH RAN node, or where the WAB-MT is being handed over, or where the WAB-MT is being dual-connected. These are situations where transmissions on a backhaul link to/from the WAB-MT may interfere with transmissions to/from the co-located WAB-gNB.

When the used frequency band(s) are different, the WAB-gNB ends the method 800 as no resource coordination is needed. When the used frequency band(s) are the same, resource coordination may be needed. Before initiating resource coordination, the WAB-gNB may assess the relevance of resource coordination. When the NG-RAN node is the backhaul RAN node or the target NG-RAN node at handover or dual-connectivity of the WAB-MT, the WAB-gNB should initiate resource coordination. Otherwise, when the strength of signals from the NG-RAN node measured at the WAB-MT is below a predefined threshold, the WAB-gNB may consider that the risk of radio interference with the NG-RAN node is low. Also, if the WAB node is moving fast it means that the WAB node will be soon in a geographical area not covered by a cell of this NG-RAN node. Then, for these reasons, the WAB-gNB may not initiate resource coordination and may stop the method 800.

If the need of resource coordination is confirmed, at step 806, the WAB-gNB checks whether the NG-RAN node controlling the interfering cell is WAB aware or not. There are several methods to obtain this information. A WAB aware NG-RAN node may broadcast a WAB support indication in SIB1 that the WAB-MT can read. The NG-RAN node may include a WAB support indication in the Xn messages to establish a Xn connection with other NG-RAN nodes (i.e. in the Xn SETUP REQUEST message and in the Xn SETUP RESPONSE message). The WAB-gNB may then establish a Xn connection with this NG-RAN node to get the information. This Xn connection setup may be performed at this step 806, or it may have already been done before the execution of method 800.

When the NG-RAN node is not WAB aware, at step 808, the WAB-gNB has to adapt the usage of its radio resource alone (that is, without involving the NG-RAN node), based on cell(s) information received at step 802, which may be regularly updated.

When the NG-RAN node is WAB aware, WAB resource coordination involving both the WAB-gNB and the NG-RAN node is feasible. For optimal resource coordination in case of WAB in-band scenario (i.e. where the NG-RAN node communicates with the WAB-MT), the NG-RAN node should discover the co-location of the WAB-gNB with the WAB-MT. Indeed, the NG-RAN may be able to locate the WAB-MT when communicating with the WAB-MT, so it may understand in which direction sending radio signals may interfere with the WAB-MT and the WAB-gNB. There are several possible mechanisms to share the WAB-MT/WAB-gNB co-location information with the NG-RAN node at step 810. For instance, the WAB-gNB may include an identifier of the WAB-MT known by the NG-RAN node in a Xn message sent by the WAB-gNB to the BH-gNB. This message may be the Xn SETUP message or NG-RAN NODE CONFIGURATION UPDATE message. For instance, when the NG-RAN node is the backhaul RAN node serving the WAB-MT, the identifier may be the Cell Radio Network Temporary Identifier (C-RNTI as defined in TS 38.300) allocated by the backhaul RAN node. When the NG-RAN node is involved in handover or dual-connectivity of the WAB-MT, the identifier may be the NG-RAN node UE XnAP ID (defined in TS 38.423 section 9.2.3.16) allocated by the NG-RAN node. This identifier may have been previously provided to the WAB-gNB by the backhaul RAN node serving the WAB-MT (via a Xn message), after performing a handover preparation procedure or a S-NG-RAN node Addition Preparation procedure with the NG-RAN node. In an alternative method, the WAB-MT may also include the identity of the WAB-gNB in a RRC message sent to the NG-RAN node, e.g. in a RRC Setup Complete message at the RRC connection establishment procedure when the NG-RAN node is the backhaul RAN node serving the WAB-MT, or in a RRC Reconfiguration Complete message when the NG-RAN node is the target NG-RAN node for handover or dual-connectivity (as a secondary node). When the WAB-gNB includes its identity in a Xn message sent to the NG-RAN node, the NG-RAN node can recognize that the Xn message comes from the WAB-gNB co-located with the WAB-MT.

At step 812, the resource coordination is initiated by the WAB-gNB sending a WAB RESOURCE COORDINATION REQUEST message to the NG-RAN node. The WAB-gNB then expects to receive a WAB RESOURCE COORDINATION RESPONSE message from the NG-RAN node at step 814. Steps 812 and 814 correspond to the WAB resource coordination procedure described at the FIG. 7. It can be noted that the sharing of WAB-MT/WAB-gNB co-location information may be performed at the same time of step 810, if an identifier of the WAB-MT known by the NG-RAN node is included in the WAB RESOURCE COORDINATION REQUEST message.

FIG. 9 is a flowchart of an example method 900 for initiating WAB resource coordination at a WAB aware backhaul NG-RAN node, i.e. a BH RAN node or BH-gNB like BH-gNB2 502 of FIG. 5. The method may be performed by software elements and/or hardware elements. The network entity may be implemented in a network node 400 as shown in and described with reference to FIG. 4 with the method being performed by an apparatus for the network entity including one or more processing units, such as the processing unit 402.

At step 902, the BH-gNB detects that the connecting device is a WAB-MT, for instance based on a WAB indication inserted by the WAB-MT in a RRC message sent to the BH-gNB (e.g. RRC Setup Complete message at the RRC connection establishment procedure).

At step 904 the BH-gNB obtains WAB-MT/WAB-gNB co-location information, for instance, as described at the step 810 of FIG. 8, with the identity of the WAB-gNB provided by the WAB-MT, or from the identifier of the WAB-MT (e.g. C-RNTI) allocated by the BH-gNB and inserted by the WAB-gNB in a Xn message sent to the BH-gNB.

At step 906, the BH-gNB evaluates the configuration to detect a WAB in-band scenario by comparing the frequency band(s) the BH-gNB uses to serve UEs (and the WAB-MT) with the frequency band(s) used at the co-located WAB-gNB. The information may be obtained with the execution of the Automatic Neighbour Cell Relation Function described in TS 38.300 section 15.3.3. For this purpose, the BH-gNB may have to setup Xn connection with the WAB-gNB (if not yet done), and then use the NG-RAN node Configuration Update procedure (specified in TS 38.423 section 8.4.2).

When the used frequency band(s) are different, the BH-gNB ends the method 900 as no resource coordination is needed. When the used frequency band(s) are the same, the WAB in-band scenario is detected. At step 908, the resource coordination is initiated by the BH-gNB sending a WAB RESOURCE COORDINATION REQUEST message to the WAB-gNB. The BH-gNB then expects to receive a WAB RESOURCE COORDINATION RESPONSE message from the WAB-gNB at step 910. Steps 908 and 910 correspond to the WAB resource coordination procedure described at the FIG. 7.

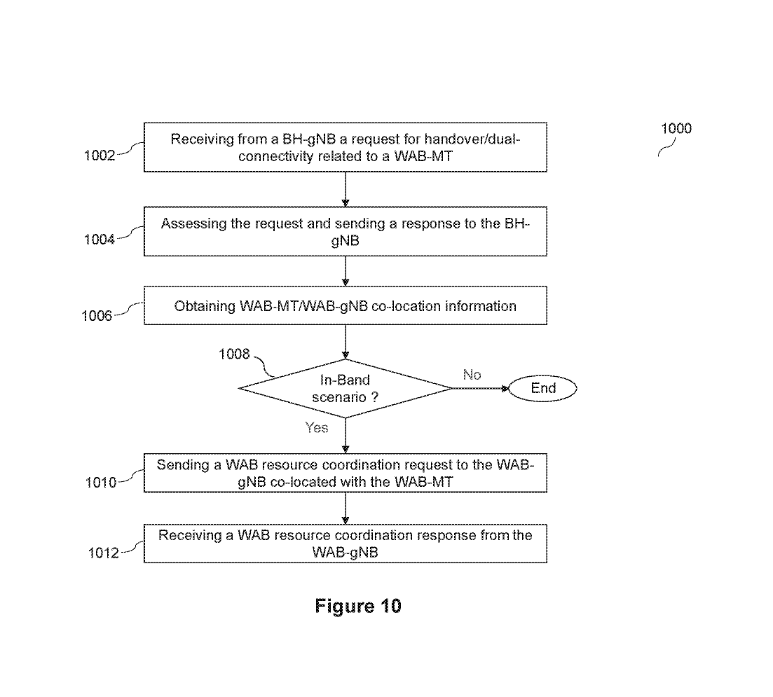

FIG. 10 is a flowchart of an example method 1000 for initiating WAB resource coordination at a WAB aware NG-RAN node involved in the handover or dual-connectivity of the MT component of a WAB node, like gNB3 503 of FIG. 5. This NG-RAN node may be referred to as a neighbour NG-RAN node or a neighbour gNB. The method may be performed by software elements and/or hardware elements. The network entity may be implemented in a network node 400 as shown in and described with reference to FIG. 4 with the method being performed by an apparatus for the network entity including one or more processing units, such as the processing unit 402.

At step 1002, the NG-RAN node receives from a backhaul base station (referred to as BH RAN node or BH-gNB) a request message for handover or dual-connectivity related to a WAB-MT. For the case of handover, the request message corresponds to the HANDOVER REQUEST message of the Handover Preparation procedure described in TS 38.423 section 8.2.1. For the case of dual-connectivity, the request message corresponds to the S-NODE ADDITION REQUEST message of the S-NG-RAN node Addition Preparation procedure described in TS 38.423 section 8.3.1. A WAB indication is included in the request message so that the NG-RAN node can understand the handover or dual-connectivity is related to the MT component of a WAB node.

At step 1004, the NG-RAN node assesses the request before sending a response to the BH-gNB following the corresponding specified procedure. Assuming the NG-RAN node has accepted the request, the NG-RAN node obtains the obtains WAB-MT/WAB-gNB co-location information at step 1006. The identity of the WAB-gNB co-located with the WAB-MT may have been obtained by the NG-RAN node at step 1002 if the BH-gNB includes the identity in the request message. As an alternative method, the WAB-MT may include the identity of the WAB-gNB in a RRC message, e.g. a RRC Reconfiguration Complete message during the handover or dual-connectivity procedure.

At step 1008, the NG-RAN node evaluates the configuration to detect a WAB in-band scenario by comparing the frequency band(s) the NG-RAN node uses to serve UEs with the frequency band(s) used at the co-located WAB-gNB. The information may be obtained with the execution of the Automatic Neighbour Cell Relation Function described in TS 38.300 section 15.3.3. For this purpose, the NG-RAN node may have to setup Xn connection with the WAB-gNB (if not yet done), and then use the NG-RAN node Configuration Update procedure (specified in TS 38.423 section 8.4.2).

When the used frequency band(s) are different, the NG-RAN node ends the method 1000 as no resource coordination is needed. When the used frequency band(s) are the same, the WAB in-band scenario is detected. At step 1010, the resource coordination is initiated by the NG-RAN node sending a WAB RESOURCE COORDINATION REQUEST message to the WAB-gNB. The NG-RAN node then expects to receive a WAB RESOURCE COORDINATION RESPONSE message from the WAB-gNB at step 1012. Steps 908 and 910 correspond to the WAB resource coordination procedure described at the FIG. 7. An information element may be inserted in the WAB RESOURCE COORDINATION REQUEST message by the NG-RAN node to indicate the reason (i.e. the cause) of this request message. The value of this cause information element can be set to the value “handover” or “dual-connectivity” depending on the scenario. This cause value may be used by the WAB-gNB to assess the relevance of performing WAB resource coordination with the NG-RAN node. As the cause value “handover” or “dual-connectivity” indicates that the NG-RAN node is likely to communicate with the WAB-MT for some time, the WAB-gNB should not reject the request and apply the WAB resource coordination with the NG-RAN node. Before positively answering to the NG-RAN node, the WAB-gNB may wait for the confirmation from the WAB-MT of the completion of the handover or the dual-connectivity procedure.

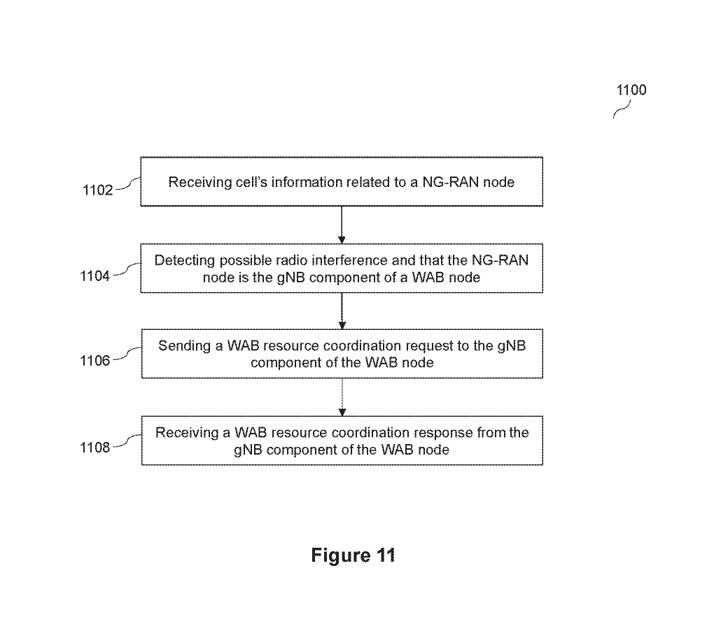

FIG. 11 is a flowchart of an example method 1100 for initiating WAB resource coordination at a WAB aware NG-RAN node like gNB3 503 or WAB-gNB 532 of FIG. 5, in the neighbourhood of a WAB node like WAB node 540 of FIG. 5. This NG-RAN node may be referred to as a neighbour NG-RAN node or a neighbour gNB. The method may be performed by software elements and/or hardware elements. The network entity may be implemented in a network node 400 as shown in and described with reference to FIG. 4 with the method being performed by an apparatus for the network entity including one or more processing units, such as the processing unit 402.

At step 1102, the neighbour NG-RAN node receives information related to cell(s) controlled by another NG-RAN node. This information may be received:
from UE(s) served by the neighbour NG-RAN node performing measurements on cell(s) in the neighbourhood and reading System Information Block 1 (SIB1) broadcasted in each cell,
from the co-located MT component of the neighbour NG-RAN node when the neighbour NG-RAN node is a WAB-node (i.e. by the WAB-MT through an interface internal to the WAB node), performing measurements on cell(s) in the neighbourhood as other legacy UEs, and reading System Information Block 1 broadcasted in each cell (SIB1 content is described in TS 38.331).
from NG-RAN nodes in the neighbourhood through an Xn interface (e.g. with NG-RAN node Configuration Update procedure).

The cell information provides NR frequency band(s) used in the cell and an identifier of the cell including an identity of the NG-RAN node controlling the cell.

This step 1102 may include the execution of the Automatic Neighbour Cell Relation Function described in TS 38.300 section 15.3.3.

At step 1104, the neighbour NG-RAN node detects possible radio interference with a cell controlled by the other NG-RAN node, and that this other NG-RAN node is the gNB component of a WAB node (i.e. a WAB-gNB). The situation with possible radio interference is detected by comparing the frequency band(s) the neighbour NG-RAN node uses to serve UEs with the frequency band(s) used at the other NG-RAN node. To detect that the other NG-RAN node is a WAB-gNB, the neighbour NG-RAN node may also rely on information reported at the step 1102, or it may setup Xn connection with the other NG-RAN node, assuming that WAB indication is inserted by the other NG-RAN node in the Xn setup message (when it is a WAB-gNB). The identity of the other NG-RAN node can be obtained from the information reported at step 1102. As an alternative method in cases of handover or dual-connectivity setup of the MT component of the WAB-node (i.e. the WAB-MT), the neighbour NG-RAN node, which, in these cases, is a target BH gNB or a target secondary node for the WAB node, may be informed that the handover/dual-connectivity is related to a WAB-MT by the source BH gNB or the master node of the WAB node. For instance, a WAB indication may be inserted in the HANDOVER REQUEST message (described in TS 38.423 section 9.1.1.1) sent by the source BH gNB in a case of handover, or in the S-NODE ADDITION REQUEST message (described in TS 38.423 section 9.1.2.1) sent by the master node in a case of dual-connectivity. This WAB indication may be in the form of the identity of the WAB-gNB (or a WAB-gNB component) co-located with the WAB-MT to be handed over or to be dual-connected. The identifier may be the Global NG-RAN Node ID (as described in TS 38.423 section 9.2.2.3) of the WAB-gNB. An advantage of using an identifier of the WAB-gNB as a WAB indication, is the provision of co-location information related to the WAB node to the neighbour NG-RAN node. Thus, the neighbour NG-RAN node can trigger WAB resource coordination with the WAB-gNB as soon as possible when WAB resource coordination is required.

In case the frequency band(s) are the same, the situation with possible radio interference is confirmed. Then, if the other NG-RAN node is a WAB-gNB, the WAB resource coordination with the other NG-RAN node is initiated by the neighbour NG-RAN node at step 1106, sending a WAB RESOURCE COORDINATION REQUEST message to the other NG-RAN node. Then, the neighbour NG-RAN node expects receiving a WAB RESOURCE COORDINATION RESPONSE message from the other NG-RAN node at step 1108. Steps 1106 and 1108 correspond to the WAB resource coordination procedure described at the FIG. 7.

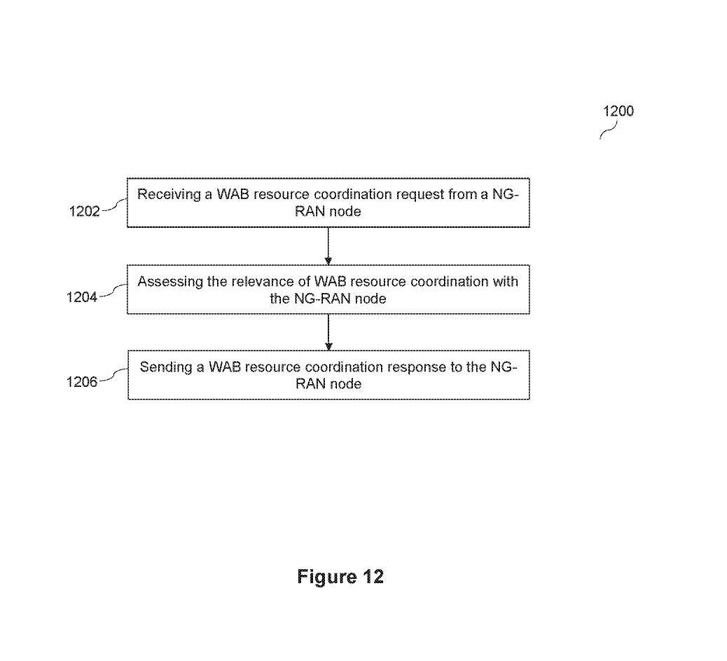

FIG. 12 is a flowchart of an example method 1200 for managing at the gNB component of a WAB node, i.e. a WAB-gNB like WAB-gNB 542, the reception of a WAB resource coordination request. The method may be performed by software elements and/or hardware elements. The network entity may be implemented in a network node 400 as shown in and described with reference to FIG. 4 with the method being performed by an apparatus for the network entity including one or more processing units, such as the processing unit 402.

At step 1202, the WAB-gNB receives a WAB RESOURCE COORDINATION REQUEST message from a NG-RAN node.

At step 1204, the WAB-gNB assesses the relevance of performing WAB resource coordination with the NG-RAN node. The WAB-gNB may use the cause value inserted in the WAB RESOURCE COORDINATION REQUEST message. If the value is set to “handover” or “dual-connectivity”, the NG-RAN node is likely to communicate for some time with the WAB-MT co-located with the WAB-gNB. Then, the WAB-gNB should not reject the request and apply the WAB resource coordination with the NG-RAN node. The WAB-gNB may also detect that the WAB RESOURCE COORDINATION REQUEST message comes from the backhaul RAN node serving the co-located WAB-MT. Here also, the WAB-gNB should accept the request and apply the WAB resource coordination with the NG-RAN node. Without particular indication in the WAB RESOURCE COORDINATION REQUEST message, the WAB-gNB may relay on the mobility status of the WAB node to assess the relevance of performing resource coordination with NG-RAN node. If the WAB node is moving fast, the WAB-gNB may reject the request. When the strength of signals from the NG-RAN node measured at the WAB-MT is below a predefined threshold, the WAB-gNB may consider that the risk of radio interference with the NG-RAN node is low, and it may also reject the request.

At step 1206, the WAB-gNB sends a WAB RESOURCE COORDINATION RESPONSE message to the NG-RAN node. In case of rejection, the WAB-gNB may insert a cause information element indicating the reason for rejecting the request, for instance with the cause value set to “mobility” if the WAB node is moving fast, or to “low risk” when the NG-RAN node’s signals strength at the WAB-MT/WAB-gNB is low.

Steps 1202 and 1206 correspond to the WAB resource coordination procedure described at the FIG. 7.

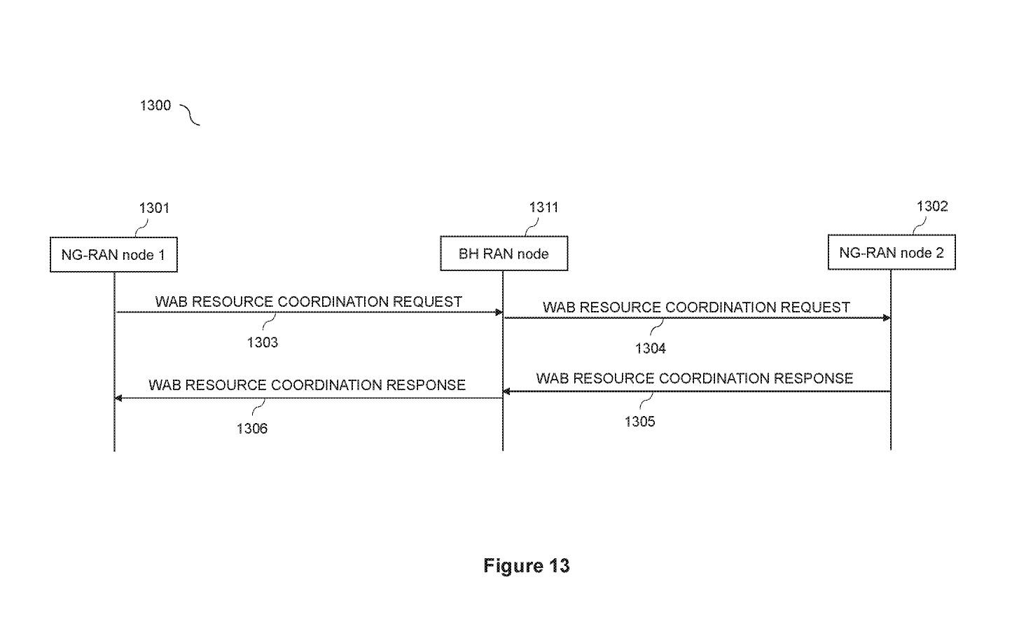

FIG. 13 is a schematic diagram 1300 showing second example message flows for managing WAB resource coordination between the gNB component of a WAB node and a WAB aware NG-RAN node. This figure shows two WAB aware NG-RAN nodes 1301 and 1302, respectively referred to as NG-RAN node 1 and NG-RAN 2, and a backhaul NG RAN node 1311 referred to as BH RAN node. NG-RAN node 1 may be the gNB component of a WAB node (i.e. a WAB-gNB), while the BH RAN node is the backhaul RAN node serving the MT component co-located with NG-RAN node 1 (i.e. the WAB-MT), and the NG-RAN node 2 is the target NG-RAN node for the handover of this WAB-MT, or the secondary node for dual-connectivity of this WAB-MT, or any NG-RAN node having no communication with this WAB-MT. Similarly, NG-RAN node 2 may be the gNB component of a WAB node (i.e. a WAB-gNB), while the BH RAN node is the backhaul RAN node serving the MT component co-located with NG-RAN node 2 (i.e. the WAB-MT), and the NG-RAN node 1 is the target NG-RAN node for the handover of this WAB-MT, or the secondary node for dual-connectivity of this WAB-MT, or any NG-RAN node having no communication with this WAB-MT.

The two WAB RESOURCE COORDINATION REQUEST messages 1303 and 1304 correspond to the message 703 of FIG. 7 and the two WAB RESOURCE COORDINATION RESPONSE messages 1305 and 1306 correspond to the message 705 of FIG. 7. The procedure 1300 illustrates with the FIG. 13 has the same function as the procedure 700 described at the FIG. 7. The procedure 1300 is used when there is no Xn connection available between the NG-RAN node 1 and NG-RAN node 2 and when resource coordination is needed between these two NG-RAN nodes. Assuming that Xn interface is available between BH-RAN node 1311 and NG-RAN node 1 and between BH-RAN node 1311 and NG-RAN node 2, the BH RAN node 1311 can be used as a relay node, relaying the received message 1303 and forwarding it with the message 1304, and relaying the received message 1305 and forwarding it with the message 1306.

For this purpose, two additional information elements have to be included by NG-RAN node 1 in the WAB RESOURCE COORDINATION REQUEST message 1303:
An identifier of the NG-RAN node 1, for instance the Global RAN Node ID as defined in TS 38.423 section 9.2.2.3, as the identifier of the initial transmitter of the message;
An identifier of the NG-RAN node 2, for instance the Global RAN Node ID as defined in TS 38.423 section 9.2.2.3, as the identifier of the final destination of the message;

By reading the identifier of the final destination of the message 1303, the BH-RAN node 1311 can forward it to the NG-RAN node 2. When receiving the message 1304, the NG-RAN node 2 understands that it actually comes from NG-RAN node 1 (by reading the identifier of the initial transmitter). Also, NG-RAN node 2 understands that it has to sends message 1305 to BH-RAN node 1311 to reach NG-RAN node 1.

In the same manner, two additional information elements have to be included by NG-RAN node 2 in the WAB RESOURCE COORDINATION RESPONSE message 1305:
An identifier of the NG-RAN node 2, for instance the Global RAN Node ID as defined in TS 38.423 section 9.2.2.3, as the identifier of the initial transmitter of the message;
An identifier of the NG-RAN node 1, for instance the Global RAN Node ID as defined in TS 38.423 section 9.2.2.3, as the identifier of the final destination of the message.

By reading the identifier of the final destination of the message 1305, the BH-RAN node 1311 can forward it to the NG-RAN node 1.

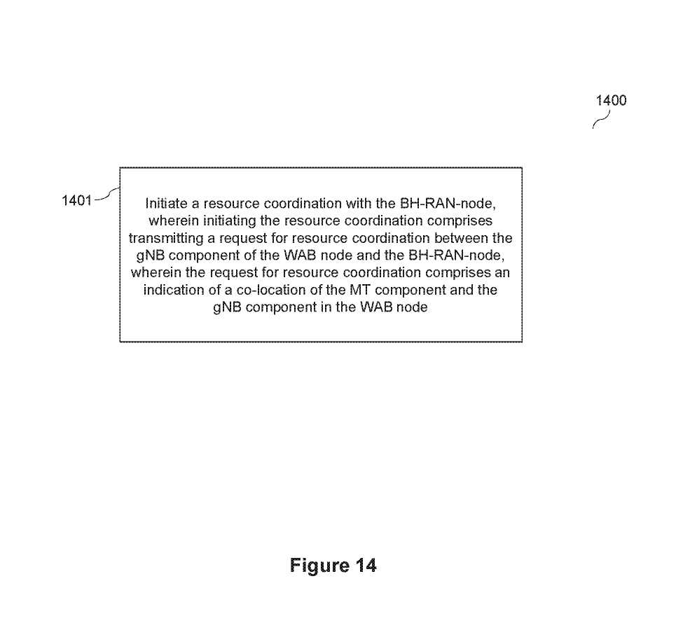

FIG. 14 is an example of a method 1400 in a wireless network, the wireless network comprising a wireless access backhaul, WAB, node comprising a mobile termination, MT, component and a gNB component, wherein the MT component of the WAB node is being served by a backhaul NG-RAN node, BH-RAN-node, in the wireless network.

The method 1400 is performed at the gNB component of the WAB node (e.g. WAB-gNB 542). The method 1400 comprises, at step 1401, initiating a resource coordination with the BH-RAN-node (e.g. BH-gNB2 502), wherein initiating the resource coordination comprises transmitting a request for resource coordination between the gNB component of the WAB node and the BH-RAN-node, wherein the request for resource coordination comprises an indication of a co-location of the MT component (e.g. WAB-MT 541) and the gNB component in the WAB node. The request for resource coordination between the gNB component of the WAB node and the BH-RAN-node may be the WAB RESOURCE COORDINATION REQUEST message 703 described with reference to FIG. 7.

By providing the co-location information to the BH-RAN node, some protocol message exchanges between the gNB component of the WAB node and the BH-RAN node serving the MT can be saved (e.g. protocol messages of NG-RAN node Configuration Update procedure).

With reference to the communication system 500 shown in and described with respect to FIG. 5, the gNB component of the WAB node may be the WAB-gNB 542. The BH-RAN-node may be the BH-gNB2 502. The MT component may be the WAB-MT 541.

The method may be performed by software elements and/or hardware elements. The gNB component of a WAB node may be implemented in a network node 400 as shown in and described with reference to FIG. 4 with the method being performed by an apparatus for the gNB component of a WAB node including one or more processing units, such as the processing unit 402.

More details of the method are described below with reference to the example method described with reference to FIG. 14.

The indication of the co-location may be co-location information comprising an identifier of the gNB component of the WAB node and an identifier of the MT component allocated by the BH-RAN node. For example, the identifier of the WAB-MT may be the Cell Radio Network Temporary Identifier (C-RNTI as defined in TS 38.300) allocated by the backhaul RAN node. When the WAB-gNB includes its identity in the request, along with the identifier of the MT component allocated by the BH-RAN node, the BH-RAN node can recognize that the request comes from the WAB-gNB co-located with the WAB-MT.

The method may further comprise receiving a response accepting or rejecting the request for resource coordination. The response accepting or rejecting the request for resource co-ordination may be the WAB RESOURCE COORDINATION RESPONSE message 705 described with reference to FIG. 7. The response accepting or rejecting the request for resource coordination may be received from the BH-RAN-node.

In some embodiments, where the response accepts the request for resource coordination, the method may further comprise performing a resource coordination with the BH-RAN-node.

In some embodiments, where the response rejects the request for resource coordination, the response may further indicate a reason that the request for resource coordination has been rejected. In some embodiments, the response may include cause information for indicating the reason that the request for resource coordination has been rejected. For example, the BH-RAN-node may insert a cause information element in the response indicating the reason for rejecting the request, for example, with the cause value set to “mobility” if the WAB node is moving fast.

In some embodiments, the method further comprises, prior to transmitting the request for resource coordination, obtaining status information associated with the WAB node, and based on status information, determining to transmit the request for resource coordination. For example, before initiating resource coordination (that is, before transmitting the request), the WAB-gNB may assess the relevance of resource coordination. For example, when the strength of signals from the BH-RAN-node measured at the WAB-MT is below a predefined threshold, the WAB-gNB may consider that the risk of radio interference with the BH-RAN-node is low. In another example, if the WAB node is moving fast, this means that the WAB node will be soon in a geographical area not covered by a cell of the BH-RAN-node. For these reasons, the WAB-gNB may not initiate resource coordination. However, if it is determined that the strength of signals from the BH-RAN-node measured at the WAB-MT is above the predefined threshold, and/or mobility information relating to the WAB node indicates that the WAB node will remain in a geographical area covered by a cell of the BH-RAN-node, the WAB-gNB may determine to initiate resource coordination (that is, to transmit the request).

In some embodiments, the status information associated with the WAB node may comprise at least one of information indicating the expected trajectory of the WAB node, information indicating a current speed of the WAB node, and information indicating a current velocity of the WAB node. As noted above, this information may be used by the WAB-gNB to assess the relevance of resource coordination, prior to initiating resource coordination.

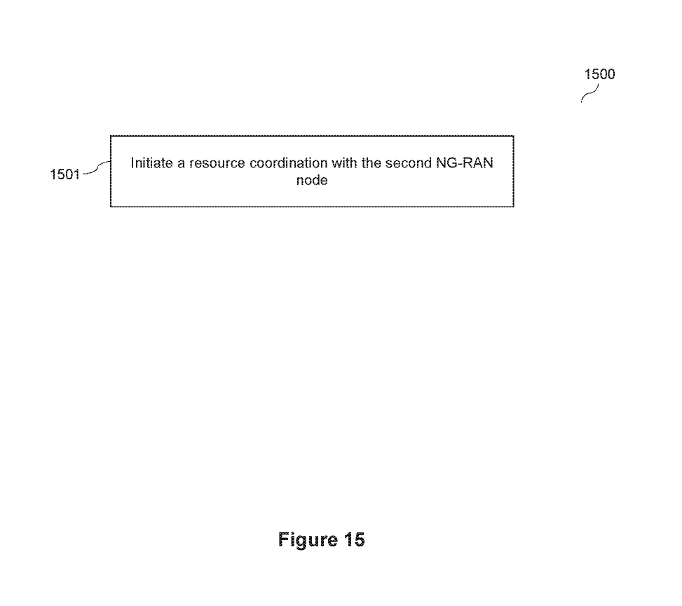

FIG. 15 is an example of a method 1500 in a wireless network, the wireless network comprising a wireless access backhaul, WAB, node comprising a mobile termination, MT, component and a gNB component, wherein the MT component of the WAB node is being served by a first NG-RAN node in the wireless network, and the wireless network further comprising a second NG-RAN node.

The method 1500 is performed at the gNB component of the WAB node (e.g. WAB-gNB 542). The method 1500 comprises, at step 1501, initiating a resource coordination with the second NG-RAN node (for example, gNB3 503).

With reference to the communication system 500 shown in and described with respect to FIG. 5, the gNB component of the WAB node may be the WAB-gNB 542. The second NG-RAN node may be the gNB3 503. The MT component may be the WAB-MT 541. The first NG-RAN node may be the BH-gNB2 502.

It is beneficial to minimize loss due to radio interference and to perform resource coordination with any NG-RAN node in the neighbourhood of the WAB node, and not only with the NG-RAN node serving the MT. Also, this method can be used to anticipate the completion of the procedure to handover or dual-connect the MT component to the NG-RAN node.

In other words, in order to minimize radio interference when a WAB-MT is handed over from a source BH-gNB to a target BH-gNB involving in-band operation, it is beneficial to quickly establish WAB resource coordination between this target BH-gNB and the WAB-gNB co-located with the WAB-MT that is being handed over. Therefore, when a WAB-MT is handed over to a target BH-gNB, WAB resource coordination, if required, between the co-located WAB-gNB and the target BH-gNB should be established as soon as possible.

The WAB-gNB could initiate the WAB resource coordination procedure, but this involves the WAB-gNB providing co-location information to the target BH-gNB. Thus, the WAB-gNB has to wait to be informed of an identifier of the WAB-MT assigned by the target BH-gNB.

A faster solution is to allow the target BH-gNB to initiate the WAB resource coordination procedure, assuming that the identifier of the WAB-gNB is provided to the target BH-gNB by the source BH-gNB, e.g. through the HANDOVER REQUEST message.

Then, at handover of a WAB-MT, WAB resource coordination, if required, may be initiated by the target BH-gNB. Also, at handover of a WAB-MT, the HANDOVER REQUEST message may include the identifier of the WAB-gNB co-located with the WAB-MT.

Therefore, in an alternative embodiment, prior to a second NG-RAN node initiating a resource coordination with a gNB component of a WAB node, the WAB node comprising a MT component and a gNB component, wherein the MT component is being served by a first NG-RAN node, the first NG-RAN node may transmit, to the second NG-RAN node, information identifying the gNB component. The information identifying the gNB component may be a Global NG-RAN Node ID of the gNB component.

In embodiments in which the first NG-RAN node is a source backhaul RAN node, source BH-RAN-node, the second NG-RAN node is a target BH-RAN-node, and the step of initiating the resource coordination is performed in response to an initiation of a handover procedure of the MT component between the source BH-RAN-node and the target BH-RAN-node, the information identifying the gNB component may be included in a handover request message, transmitted by the source BH-RAN node to the target BH-RAN-node.

In embodiments in which the first NG-RAN node is a master node, MN, for dual-connectivity of the MT component of the WAB node, the second NG-RAN node is a secondary node RAN-node, SN, for dual-connectivity of the MT component of the WAB node, and the step of initiating the resource coordination is performed in response to an initiation of a procedure to configure dual connectivity for the MT component of the WAB node, the information identifying the gNB component may be included in a SN addition request message, transmitted by the MN to the SN.

The method may be performed by software elements and/or hardware elements. The gNB component of a WAB node may be implemented in a network node 400 as shown in and described with reference to FIG. 4 with the method being performed by an apparatus for the gNB component of a WAB node including one or more processing units, such as the processing unit 402.

More details of the method are described below with reference to the example method described with reference to FIG. 15.

In some embodiments, prior to initiating a resource coordination with the second NG-RAN node, the method may further comprise receiving information related to a cell controlled by the second NG-RAN node, as described at step 802 of FIG. 8. In some embodiments, the method may further comprise, based on the received information, determining whether radio interference may occur between a cell of the WAB-gNB, and the cell controlled by the second NG-RAN node, as described at step 804 of FIG. 8. In response to determining that radio interference may occur between these cells (or that a WAB in-band scenario has been detected), the WAB-gNB may determine to initiate resource coordination.

In some embodiments, prior to initiating a resource coordination with the second NG-RAN node, the method may further comprise determining whether the second NG-RAN node is WAB aware or not, as described at step 806 of FIG. 8. In response to determining that the second NG-RAN node is WAB aware, the WAB-gNB may determine to initiate resource coordination.

In some embodiments, initiating the resource coordination with the second NG-RAN node may comprise transmitting a request for resource coordination between the gNB component of the WAB node and the second NG-RAN node. The request for resource coordination between the gNB component of the WAB node and the second NG-RAN node may be the WAB RESOURCE COORDINATION REQUEST message 703 described with reference to FIG. 7.

In some embodiments, the request for resource coordination may be transmitted to the second NG-RAN node (for example, when there is an Xn connection available between the gNB component of the WAB node and the second NG-RAN node). Alternatively, the request for resource coordination may be transmitted to the first NG-RAN node. For example, when there is no Xn connection available between the gNB component of the WAB node and the second NG-RAN node, the first NG-RAN node can be used as a relay node, relaying the request to the second NG-RAN node, as described with reference to FIG. 13.

The request for resource coordination may comprise an identifier of the gNB component of the WAB node and/or an identifier of the second NG-RAN node. This may enable the first NG-RAN node, when acting as a relay node, to relay the request to the second NG-RAN node, as described with reference to FIG. 13.

In some embodiments, the request for resource coordination may comprise an indication of a co-location of the MT component and the gNB component in the WAB node. For example, when the second NG-RAN node is the backhaul RAN node serving the WAB-MT, the identifier of the WAB-MT may be the Cell Radio Network Temporary Identifier (C-RNTI as defined in TS 38.300) allocated by the backhaul RAN node. For example, when the second NG-RAN node is involved in handover or dual-connectivity of the WAB-MT, the identifier may be the NG-RAN node UE XnAP ID (defined in TS 38.423 section 9.2.3.16) allocated by the second NG-RAN node. When the WAB-gNB includes its identity in the request, along with the identifier of the MT component allocated by the second NG-RAN node, the second NG-RAN node can recognize that the request comes from the WAB-gNB co-located with the WAB-MT.

Alternatively, method may further comprise transmitting the indication of a co-location of the MT component and the gNB component in the WAB node, in a separate message to the request, to the second NG-RAN node, as described at the step 810 of FIG. 8.

The method may further comprise receiving a response accepting or rejecting the request for resource coordination between the gNB component of the WAB node and the second NG-RAN node. The response accepting or rejecting the request for resource co-ordination may be the WAB RESOURCE COORDINATION RESPONSE message 705 described with reference to FIG. 7. The response to the request for resource coordination may comprise an identifier of the gNB component of the WAB node and/or an identifier of the second NG-RAN node. This may enable the first NG-RAN node, when acting as a relay node, to relay the response to the gNB component of the WAB node, as described with reference to FIG. 13.

The response accepting or rejecting the request for resource coordination may be received from the second NG-RAN node (for example, when there is an Xn connection available between the gNB component of the WAB node and the second NG-RAN node). Alternatively, the response accepting or rejecting the request for resource coordination may be received from the first NG-RAN node. For example, when there is no Xn connection available between the gNB component of the WAB node and the second NG-RAN node, the first NG-RAN node can be used as a relay node, relaying the response to the gNB component of the WAB node, as described with reference to FIG. 13.

In some embodiments, when the response accepts the request for resource coordination between the gNB component of the WAB node and the second NG-RAN node, the method may further comprise performing a resource coordination with the second NG-RAN node.

In some embodiments, when the response rejects the request for resource coordination, the response may further indicate a reason that the request for resource coordination has been rejected. In some embodiments, the response may include cause information for indicating the reason that the request for resource coordination has been rejected. For example, the second NG-RAN-node may insert a cause information element in the response indicating the reason for rejecting the request, for example, with the cause value set to “mobility” if the request has been rejected as the WAB node is moving fast.

In some embodiments, the method further comprises, prior to transmitting the request for resource coordination, obtaining status information associated with the WAB node, and based on status information, determining to transmit the request for resource coordination. For example, before initiating resource coordination (that is, before transmitting the request), the WAB-gNB may assess the relevance of resource coordination. For example, when the strength of signals from the second NG-RAN node measured at the WAB-MT is below a predefined threshold, the WAB-gNB may consider that the risk of radio interference with the second NG-RAN node is low. In another example, if the WAB node is moving fast, this means that the WAB node will be soon in a geographical area not covered by a cell of the second NG-RAN node. For these reasons, the WAB-gNB may not initiate resource coordination. However, if it is determined that the strength of signals from the second NG-RAN node measured at the WAB-MT is above the predefined threshold, and/or mobility information relating to the WAB node indicates that the WAB node will remain in a geographical area covered by a cell of the second NG-RAN node, the WAB-gNB may determine to initiate resource coordination (that is, to transmit the request).

In some embodiments, the status information associated with the WAB node may comprise at least one of information indicating the expected trajectory of the WAB node, information indicating a current speed of the WAB node, and information indicating a current velocity of the WAB node. As noted above, this information may be used by the WAB-gNB to assess the relevance of resource coordination, prior to initiating resource coordination.

In some embodiments, the first NG-RAN node is a source backhaul RAN node, source BH-RAN-node, the second NG-RAN node is a target BH-RAN-node, and the step of initiating the resource coordination is performed in response to an initiation of a handover procedure of the MT component between the source BH-RAN-node and the target BH-RAN-node.

In some embodiments, prior to initiating the resource coordination, the method may further comprise receiving, from the source BH-RAN-node, information identifying the target BH-RAN-node and information identifying the MT component at the target BH-RAN-node.

In some embodiments, prior to initiating the resource coordination, the method may comprise establishing an Xn connection with the target BH-RAN-node.

In some embodiments, the first NG-RAN node is a master node, MN, for dual-connectivity of the MT component of the WAB node, the second NG-RAN node is a secondary node, SN, for dual-connectivity of the MT component of the WAB node, and the step of initiating the resource coordination is performed in response to an initiation of a procedure to configure dual connectivity for the MT component of the WAB node.

In some embodiments, prior to initiating the resource coordination, the method may further comprise receiving, from the MN, information identifying the SN and information identifying the MT component at the SN.

In some embodiments, prior to initiating the resource coordination, the method may further comprise establishing an Xn connection with the SN.

In some embodiments, the first NG-RAN node is a backhaul RAN node, BH- RAN-node, the second NG-RAN node is a master node, MN for dual-connectivity of a user equipment, UE, and wherein the gNB component of the WAB node is a secondary node, SN, for dual-connectivity of the UE.

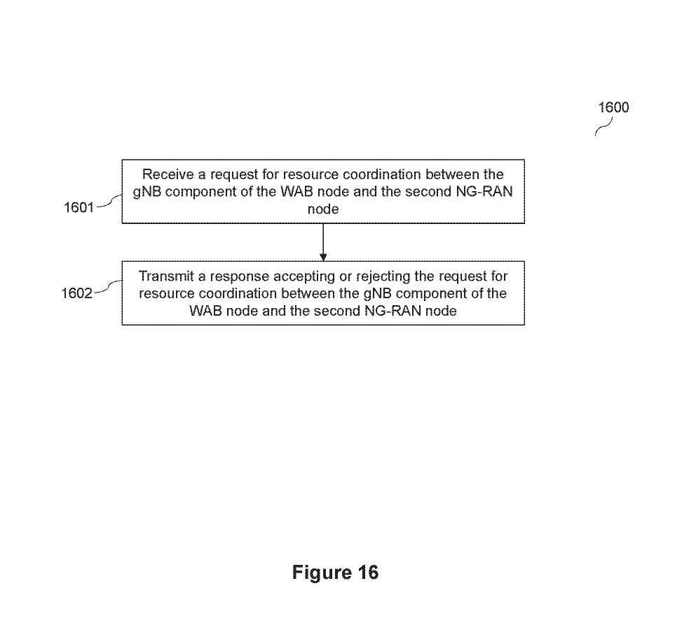

FIG. 16 is an example of a method 1600 in a wireless network, the wireless network comprising a wireless access backhaul, WAB, node comprising a mobile termination, MT, component and a gNB component, wherein the MT component is being served by a first NG-RAN node in the wireless network, and the wireless network further comprising a second NG-RAN node.

The method 1600 is performed at the gNB component of the WAB node (e.g. WAB-gNB 542). The method 1600 comprises, at step 1601, receiving a request for resource coordination between the gNB component of the WAB node and the second NG-RAN node (for example, gNB3 503). The request for resource coordination may be the WAB RESOURCE COORDINATION REQUEST message 703 described with reference to FIG. 7.

The method 1600 further comprises, at step 1602, transmitting a response accepting or rejecting the request for resource coordination between the gNB component of the WAB node and the second NG-RAN node. The response accepting or rejecting the request for resource co-ordination may be the WAB RESOURCE COORDINATION RESPONSE message 705 described with reference to FIG. 7.

With reference to the communication system 500 shown in and described with respect to FIG. 5, the gNB component of the WAB node may be the WAB-gNB 542. The BH-RAN-node may be the BH-gNB3 503. The MT component may be the WAB-MT 541. The first NG-RAN node may be BH-gNB2 502.

The method may be performed by software elements and/or hardware elements. The gNB component of a WAB node may be implemented in a network node 400 as shown in and described with reference to FIG. 4 with the method being performed by an apparatus for the gNB component of a WAB node including one or more processing units, such as the processing unit 402.

More details of the method are described below with reference to the example method described with reference to FIG. 16.

In some embodiments, the request for resource coordination may be received from the second NG-RAN node (for example, when there is an Xn connection available between the gNB component of the WAB node and the second NG-RAN node). Alternatively, the request for resource coordination may be received from the first NG-RAN node. For example, when there is no Xn connection available between the gNB component of the WAB node and the second NG-RAN node, the first NG-RAN node can be used as a relay node, relaying the request to the gNB component of the WAB node, as described with reference to FIG. 13.

The request for resource coordination may comprise an identifier of the gNB component of the WAB node and/or an identifier of the second NG-RAN node. This may enable the first NG-RAN node, when acting as a relay node, to relay the request to the gNB component of the WAB node, as described with reference to FIG. 13.

In some embodiments, the request for resource coordination may comprise cause information indicating the reason that resource coordination has been requested. For example, an information element may be inserted in the WAB RESOURCE COORDINATION REQUEST message by the second NG-RAN node to indicate the reason (i.e. the cause) of the request message. The value of this cause information element can be set to the value “handover” or “dual-connectivity” depending on the whether resource co-ordination is required as a result of performing/initiating a handover procedure, or as a result of performing/initiating a procedure to configure dual connectivity. This cause value may be used by the gNB component of the WAB node to assess the relevance of performing WAB resource coordination with the second NG-RAN node. As a cause value of “handover” or “dual-connectivity” indicates that the second NG-RAN node is likely to communicate with the WAB-MT for some time, the WAB-gNB may use this information to determine that it should not reject the request, and apply the WAB resource coordination with the second NG-RAN node.

In some embodiments, the response accepting or rejecting the request for resource coordination may be transmitted to the second NG-RAN node (for example, when there is an Xn connection available between the gNB component of the WAB node and the second NG-RAN node). Alternatively, the response accepting or rejecting the request for resource coordination may be transmitted to the first NG-RAN node. For example, when there is no Xn connection available between the gNB component of the WAB node and the second NG-RAN node, the first NG-RAN node can be used as a relay node, relaying the response to the second NG-RAN node, as described with reference to FIG. 13.

In some embodiments, when the response accepts the request for resource coordination between the gNB component of the WAB node and the second NG-RAN node, the method may further comprise performing a resource coordination with the second NG-RAN node.

In some embodiments, the method further comprises, prior to transmitting the response, obtaining status information associated with the WAB node, and based on status information, determining whether to accept or reject the request. This determination may comprise assessing the relevance of performing WAB resource coordination with the second NG-RAN node, as described at step 1204 of FIG. 12.

For example, when the strength of signals from the second NG-RAN node measured at the WAB-MT is below a predefined threshold, the WAB-gNB may consider that the risk of radio interference with the second NG-RAN node is low. In another example, if the WAB node is moving fast, this means that the WAB node will be soon in a geographical area not covered by a cell of the second NG-RAN node. For these reasons, the WAB-gNB may reject the request for resource coordination. However, if it is determined that the strength of signals from the second NG-RAN node measured at the WAB-MT is above the predefined threshold, and/or mobility information relating to the WAB node indicates that the WAB node will remain in a geographical area covered by a cell of the second NG-RAN node, the WAB-gNB may determine to accept the request for resource coordination.

In some embodiments, the status information associated with the WAB node may comprise at least one of information indicating the expected trajectory of the WAB node, information indicating a current speed of the WAB node, and information indicating a current velocity of the WAB node. As noted above, this information may be used by the WAB-gNB to assess the relevance of resource coordination, prior to accepting or rejecting a request for resource coordination.

For example, the WAB-gNB may use a cause value inserted in the WAB RESOURCE COORDINATION REQUEST message. If the value is set to “handover” or “dual-connectivity”, the second NG-RAN node is likely to communicate for some time with the WAB-MT co-located with the WAB-gNB. In this case, the WAB-gNB may determine to apply the WAB resource coordination with the second NG-RAN node. The WAB-gNB may also detect that the WAB RESOURCE COORDINATION REQUEST message comes from the backhaul RAN node serving the co-located WAB-MT. In this case, the WAB-gNB may determine to apply the WAB resource coordination with the second NG-RAN node. Without a particular indication in the WAB RESOURCE COORDINATION REQUEST message, the WAB-gNB may rely on the mobility status of the WAB node to assess the relevance of performing resource coordination with second NG-RAN node. If the WAB node is moving fast, the WAB-gNB may reject the request. When the strength of signals from the second NG-RAN node measured at the WAB-MT is below a predefined threshold, the WAB-gNB may consider that the risk of radio interference with the second NG-RAN node is low, and it may also reject the request.

In response to determining to perform WAB resource coordination with the second NG-RAN node, the WAB-gNB may then transmit a response accepting the request for resource coordination. In response to determining not to perform WAB resource coordination with the second NG-RAN node, the WAB-gNB may then transmit a response rejecting the request for resource coordination.

In some embodiments, when the response rejects the request for resource coordination, the response may further indicate a reason that the request for resource coordination has been rejected. In some embodiments, the response may include cause information for indicating the reason that the request for resource coordination has been rejected. For example, the gNB component of the WAB node may insert a cause information element in the response indicating the reason for rejecting the request, for example, with the cause value set to “mobility” if the WAB node is moving fast, or with the cause value set to “low risk” when the second NG-RAN node’s signals strength at the WAB-MT/WAB-gNB is low.

In some embodiments, the response to the request for resource coordination comprises an identifier of the gNB component of the WAB node and/or an identifier of the second NG-RAN node. This may enable the first NG-RAN node, when acting as a relay node, to relay the response to the second NG-RAN node, as described with reference to FIG. 13.

In some embodiments, the first NG-RAN node is a source backhaul RAN node, source BH-RAN-node, the second NG-RAN node is a target BH-RAN-node, and the step of receiving a request for resource coordination is performed following an initiation of a handover procedure of the MT component between the source BH-RAN-node and the target BH-RAN-node.

In some embodiments, the first NG-RAN node is a master node backhaul, MN, for dual-connectivity of the MT component of the WAB node, the second NG-RAN node is a secondary node, SN, for dual-connectivity of the MT component of the WAB node, and the step of initiating the resource coordination is performed in response to an initiation of a procedure to configure dual connectivity for the MT component of the WAB node.

In some embodiments, the first NG-RAN node is a backhaul RAN node, BH-RAN-node, the second NG-RAN node is a master node, MN, for dual-connectivity of a user equipment, UE, and the gNB component of the WAB node is a secondary node, SN, for dual-connectivity of the UE.

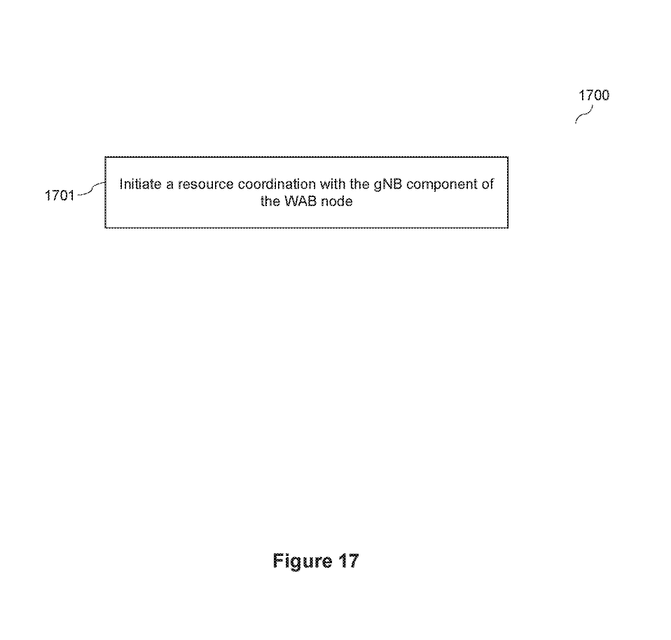

FIG. 17 is an example of a method 1700 in a wireless network, the wireless network comprising a wireless access backhaul, WAB, node comprising a mobile termination, MT, component and a gNB component, wherein the MT component is being served by a first NG-RAN node in the wireless network, and the wireless network further comprising a second NG-RAN node.

The method 1700 is performed at the second NG-RAN node (e.g. gNB3 503). The method 1700 comprises, at step 1701, initiating a resource coordination with the gNB component of the WAB node.

In some embodiments, prior to the second NG-RAN node initiating a resource coordination with the gNB component of the WAB node, the second NG-RAN node may receive, from the first NG-RAN node, information identifying the gNB component. The information identifying the gNB component may be a Global NG-RAN Node ID of the gNB component.With reference to the communication system 500 shown in and described with respect to FIG. 5, the gNB component of the WAB node may be the WAB-gNB 542. The BH-RAN-node may be the BH-gNB3 503. The MT component may be the WAB-MT 541. The first NG-RAN node may be BH-gNB2 502.

The method may be performed by software elements and/or hardware elements. The second NG-RAN node may be implemented in a network node 400 as shown in and described with reference to FIG. 4 with the method being performed by an apparatus for second NG-RAN node including one or more processing units, such as the processing unit 402.

More details of the method are described below with reference to the example method described with reference to FIG. 17.

In some embodiments, initiating the resource coordination with the gNB component of the WAB node may comprise transmitting a request for resource coordination between the gNB component of the WAB node and the second NG-RAN node. The request for resource coordination between the gNB component of the WAB node and the second NG-RAN node may be the WAB RESOURCE COORDINATION REQUEST message 703 described with reference to FIG. 7.

In some embodiments, the request for resource coordination may be transmitted to the gNB component of the WAB node (for example, when there is an Xn connection available between the gNB component of the WAB node and the second NG-RAN node). Alternatively, the request for resource coordination may be transmitted to the first NG-RAN node. For example, when there is no Xn connection available between the gNB component of the WAB node and the second NG-RAN node, the first NG-RAN node can be used as a relay node, relaying the request to the gNB component of the WAB node, as described with reference to FIG. 13.

The request for resource coordination may comprise an identifier of the gNB component of the WAB node and/or an identifier of the second NG-RAN node. This may enable the first NG-RAN node, when acting as a relay node, to relay the request to the gNB component of the WAB node, as described with reference to FIG. 13.

In some embodiments, the request for resource coordination may comprise cause information for indicating the reason that resource coordination has been requested. For example, an information element may be inserted in the WAB RESOURCE COORDINATION REQUEST message by the second NG-RAN node to indicate the reason (i.e. the cause) of the request message. The value of this cause information element can be set to the value “handover” or “dual-connectivity” depending on the whether resource co-ordination is required as a result of performing a handover procedure, or as a result of performing a procedure to configure dual connectivity. This cause value may be used by the gNB component of the WAB node to assess the relevance of performing WAB resource coordination with the second NG-RAN node. As a cause value of “handover” or “dual-connectivity” indicates that the second NG-RAN node is likely to communicate with the WAB-MT for some time, the gNB component of the WAB node may use this information to determine that it should not reject the request, and apply the WAB resource coordination with the second NG-RAN node.

In some embodiments, the method may further comprise receiving an indication of a co-location of the MT component and the gNB component in the WAB node, as described at step 1006 of FIG. 10.

In some embodiments, prior to initiating a resource coordination, the method may further comprise receiving information related to a cell controlled by the gNB component of the WAB node, as described at step 1102 of FIG. 11. In some embodiments, the method may further comprise, based on the received information, determining whether radio interference may occur between a cell of the WAB-gNB, and the cell controlled by the second NG-RAN node, as described at step 1104 of FIG. 11. In response to determining that radio interference may occur between these cells (or that a WAB in-band scenario has been detected), the second NG-RAN node may determine to initiate resource coordination.

In some embodiments the method further comprises receiving a response accepting or rejecting the request for resource coordination between the gNB component of the WAB node and the second NG-RAN node. The response accepting or rejecting the request for resource co-ordination may be the WAB RESOURCE COORDINATION RESPONSE message 705 described with reference to FIG. 7.

In some embodiments, the response accepting or rejecting the request for resource coordination may be received from the gNB component of the WAB node (for example, when there is an Xn connection available between the gNB component of the WAB node and the second NG-RAN node). Alternatively, the response accepting or rejecting the request for resource coordination may be received from the first NG-RAN node. For example, when there is no Xn connection available between the gNB component of the WAB node and the second NG-RAN node, the first NG-RAN node can be used as a relay node, relaying the request to the second NG-RAN node, as described with reference to FIG. 13.

In some embodiments, when the response accepts the request for resource coordination between the gNB component of the WAB node and the second NG-RAN node, and the method may further comprise performing a resource coordination with the gNB component of the WAB node.

In some embodiments, when the response rejects the request for resource coordination, the response may further indicate a reason that the request for resource coordination has been rejected. In some embodiments, the response may include cause information for indicating the reason that the request for resource coordination has been rejected. For example, the gNB component of the WAB node may insert a cause information element in the response indicating the reason for rejecting the request, for instance with the cause value set to “mobility” if the WAB node is moving fast, or with the cause value set to “low risk” when the second NG-RAN node’s signals strength at the WAB-MT/WAB-gNB is low.

In some embodiments, the response to the request for resource coordination may comprise an identifier of the gNB component of the WAB node and/or an identifier of the second NG-RAN node. This may enable the first NG-RAN node, when acting as a relay node, to relay the response to the second NG-RAN node, as described with reference to FIG. 13.

In some embodiments, the method further comprises, prior to transmitting the request for resource coordination, obtaining status information associated with the WAB node, and based on status information, determining to transmit the request for resource coordination. For example, before initiating resource coordination (that is, before transmitting the request), if the WAB node is moving fast, this means that the WAB node will be soon in a geographical area not covered by a cell of the second NG-RAN node. For this reason, the second NG-RAN node may not initiate resource coordination. However, if it is determined that mobility information relating to the WAB node indicates that the WAB node will remain in a geographical area covered by a cell of the second NG-RAN-node, the second NG-RAN-node may determine to initiate resource coordination (that is, to transmit the request).

In some embodiments, the status information associated with the WAB node may comprise at least one of information indicating the expected trajectory of the WAB node, information indicating a current speed of the WAB node, and information indicating a current velocity of the WAB node. As noted above, this information may be used by the second NG-RAN-node to assess the relevance of resource coordination, prior to initiating resource coordination.

In some embodiments, the first NG-RAN node is a source backhaul RAN node, source BH-RAN-node, the second NG-RAN node is a target BH-RAN-node, and the step of initiating the resource coordination is performed in response to an initiation of a handover procedure of the MT component between the source BH-RAN-node and the target BH-RAN-node. For example, the second NG-RAN node may transmit the request for resource coordination following the reception of the message 1002 at the second NG-RAN node described with reference to FIG. 10. Alternatively, the second NG-RAN node may transmit the request for resource coordination in response to following the transmission of message 1004 described with reference to FIG. 10.

In these embodiments, the information identifying the gNB component (described above) may be received in a handover request message. In some embodiments, prior to initiating the resource coordination, the method may further comprise establishing an Xn connection with the gNB component of the WAB node.

In some embodiments, the first NG-RAN node is a master node, MN, for dual-connectivity of the MT component of the WAB node, the second NG-RAN node is a secondary node, SN, for dual-connectivity of the MT component of the WAB node, and the step of initiating the resource coordination is performed in response to an initiation of a procedure to configure dual connectivity for the MT component of the WAB node. For example, the second NG-RAN node may transmit the request for resource coordination in response to the reception of the message 1002 at the second NG-RAN node described with reference to FIG. 10. Alternatively, the second NG-RAN node may transmit the request for resource coordination in response to following the transmission of message 1004 described with reference to FIG. 10.

In these embodiments, the information identifying the gNB component (described above) may be received in a SN addition request message.

In some embodiments, prior to initiating the resource coordination, the method may further comprise establishing an Xn connection with the SN.

In some embodiments, the first NG-RAN node is a backhaul RAN node, BH-RAN-node, the second NG-RAN node is a master node, MN, for a user equipment, UE, and wherein the gNB component of the WAB node is a secondary node, SN, for the UE.

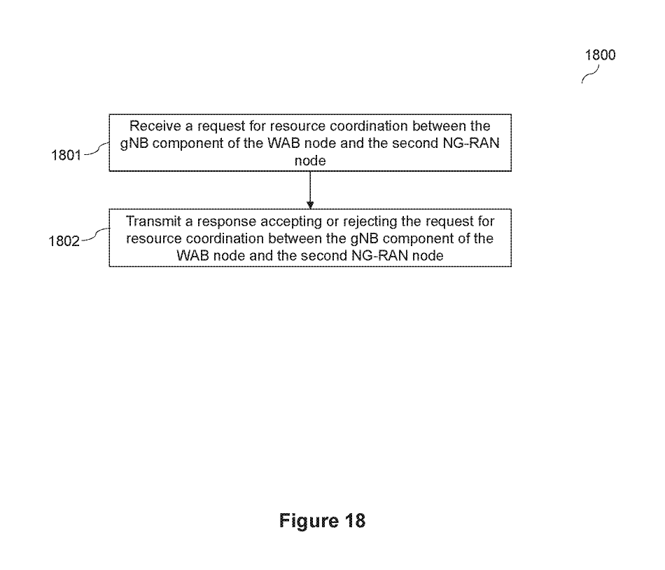

FIG. 18 is an example of a method 1800 in a wireless network, the wireless network comprising a wireless access backhaul, WAB, node comprising a mobile termination, MT, component and a gNB component, wherein the MT component is being served by a first NG-RAN node in the wireless network, and the wireless network further comprising a second NG-RAN node.

The method 1800 is performed at the second NG-RAN node (e.g. gNB3 503). The method 1800 comprises, at step 1801, receiving a request for resource coordination between the gNB component of the WAB node and the second NG-RAN node. The request for resource coordination may be the WAB RESOURCE COORDINATION REQUEST message 703 described with reference to FIG. 7

At step 1802, the method 1800 further comprises transmitting a response accepting or rejecting the request for resource coordination between the gNB component of the WAB node and the second NG-RAN node. The response accepting or rejecting the request for resource co-ordination may be the WAB RESOURCE COORDINATION RESPONSE message 705 described with reference to FIG. 7.

With reference to the communication system 500 shown in and described with respect to FIG. 5, the gNB component of the WAB node may be the WAB-gNB 542. The BH-RAN-node may be the BH-gNB3 503. The MT component may be the WAB-MT 541. The first NG-RAN node may be BH-gNB2 502.

The method may be performed by software elements and/or hardware elements. The second NG-RAN node may be implemented in a network node 400 as shown in and described with reference to FIG. 4 with the method being performed by an apparatus for second NG-RAN node including one or more processing units, such as the processing unit 402.

More details of the method are described below with reference to the example method described with reference to FIG. 18.

In some embodiments, the request for resource coordination may be received from the gNB component of the WAB node (for example, when there is an Xn connection available between the gNB component of the WAB node and the second NG-RAN node). Alternatively, the request for resource coordination may be received from the first NG-RAN node. For example, when there is no Xn connection available between the gNB component of the WAB node and the second NG-RAN node, the first NG-RAN node can be used as a relay node, relaying the request to the second NG-RAN node, as described with reference to FIG. 13.

In some embodiments, the request for resource coordination may comprise an identifier of the gNB component of the WAB node and/or an identifier of the second NG-RAN node. This may enable the first NG-RAN node, when acting as a relay node, to relay the request to the second NG-RAN node, as described with reference to FIG. 13.

In some embodiments, the request for resource coordination may comprise cause information for indicating the reason that resource coordination has been requested. For example, an information element may be inserted in the WAB RESOURCE COORDINATION REQUEST message by the gNB component of the WAB node to indicate the reason (i.e. the cause) of the request message. The value of this cause information element can be set to the value “handover” or “dual-connectivity” depending on the whether resource co-ordination is required as a result of performing/initiating a handover procedure, or as a result of performing/initiating a procedure to configure dual connectivity. This cause value may be used by the second NG-RAN node to assess the relevance of performing WAB resource coordination with the gNB component of the WAB node. As a cause value of “handover” or “dual-connectivity” indicates that the second NG-RAN node is likely to communicate with the WAB-MT for some time, the second NG-RAN node may use this information to determine that it should not reject the request, and apply the WAB resource coordination.

In some embodiments, the request for resource coordination may comprise an indication of a co-location of the MT component and the gNB component in the WAB node. For example, when the second NG-RAN node is the backhaul RAN node serving the WAB-MT, the identifier of the WAB-MT may be the Cell Radio Network Temporary Identifier (C-RNTI as defined in TS 38.300) allocated by the backhaul RAN node. For example, when the second NG-RAN node is involved in handover or dual-connectivity of the WAB-MT, the identifier may be the NG-RAN node UE XnAP ID (defined in TS 38.423 section 9.2.3.16) allocated by the second NG-RAN node. When the WAB-gNB includes its identity in the request, along with the identifier of the MT component allocated by the second NG-RAN node, the second NG-RAN node can recognize that the request comes from the WAB-gNB co-located with the WAB-MT.

In some embodiments, the response accepting or rejecting the request for resource coordination may be transmitted to the gNB component of the WAB node (for example, when there is an Xn connection available between the gNB component of the WAB node and the second NG-RAN node). Alternatively, the response accepting or rejecting the request for resource coordination may be transmitted to the first NG-RAN node. For example, when there is no Xn connection available between the gNB component of the WAB node and the second NG-RAN node, the first NG-RAN node can be used as a relay node, relaying the response to the gNB component of the WAB node, as described with reference to FIG. 13.

In some embodiments, when the response accepts the request for resource coordination between the gNB component of the WAB node and the second NG-RAN node, the method may further comprise performing a resource coordination with the gNB component of the WAB node.

In some embodiments, when the response rejects the request for resource coordination, the response may further indicate a reason that the request for resource coordination has been rejected. In some embodiments, the response may include cause information for indicating the reason that the request for resource coordination has been rejected. For example, the second NG-RAN-node may insert a cause information element in the response indicating the reason for rejecting the request, for instance with the cause value set to “mobility” if the WAB node is moving fast.

In some embodiments, the response to the request for resource coordination may comprise an identifier of the gNB component of the WAB node and/or an identifier of the second NG-RAN node. This may enable the first NG-RAN node, when acting as a relay node, to relay the response to the gNB component of the WAB node, as described with reference to FIG. 13.

In some embodiments, the method further comprises, prior to transmitting the response, obtaining status information associated with the WAB node, and based on status information, determining whether to accept or reject the request. This determination may comprise assessing the relevance of performing WAB resource coordination with the second NG-RAN node.

For example, when the WAB node is moving fast, this means that the WAB node will be soon in a geographical area not covered by a cell of the second NG-RAN node. For these reasons, the second NG-RAN node may reject the request for resource coordination. However, if it is determined that mobility information relating to the WAB node indicates that the WAB node will remain in a geographical area covered by a cell of the second NG-RAN node, the second NG-RAN node may determine to accept the request for resource coordination.

In some embodiments, the status information associated with the WAB node may comprise at least one of information indicating the expected trajectory of the WAB node, information indicating a current speed of the WAB node, and information indicating a current velocity of the WAB node. As noted above, this information may be used by the second NG-RAN node to assess the relevance of resource coordination, prior to accepting or rejecting a request for resource coordination.

In some embodiments, the first NG-RAN node is a source backhaul RAN node, source BH-RAN-node, the second NG-RAN node is a target BH-RAN-node, and the step of receiving a request for resource coordination is performed following an initiation of a handover procedure of the MT component between the source BH-RAN-node and the target BH-RAN-node.

In some embodiments, the first NG-RAN node is a master node backhaul, MN, for dual-connectivity of the MT component of the WAB node, the second NG-RAN node is a secondary node, SN B, for dual-connectivity of the MT component of the WAB node, and the step of initiating the resource coordination is performed in response to an initiation of a procedure to configure dual connectivity for the MT component of the WAB node.

In some embodiments, the first NG-RAN node is a backhaul RAN node, BH-RAN-node, the second NG-RAN node is a master node, MN, for dual-connectivity of a user equipment, UE, and the gNB component of the WAB node is a secondary node, SN, for dual-connectivity of the UE.

While the present invention has been described with reference to examples and embodiments, it is to be understood that the invention is not limited to the disclosed examples and embodiments. It will be appreciated by those skilled in the art that various changes and modification might be made without departing from the scope of the invention, as defined in the appended claims. All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

Unless otherwise defined herein, scientific and technical terms used in connection with the presently disclosed inventive concept(s) shall have the meanings that are commonly understood by those of ordinary skill in the art, and known techniques and procedures may be performed according to conventional methods well known in the art and as described in various general and more specific references that may be cited and discussed in the present specification.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

As used in this specification and claim(s), the words “comprising, “having,” “including,” or “containing” (and any forms thereof, such as “comprise” and “comprises,” “have” and “has,” “includes” and “include,” or “contains” and “contain,” respectively) are inclusive or open-ended and do not exclude additional, unrecited elements or method steps. The use of the term “a” or “an” in the claims and/or the specification may mean “one,” as well as “one or more,” “at least one,” and “one or more than one.” As such, the terms “a,” “an,” and “the,” as well as all singular terms, include plural referents unless the context clearly indicates otherwise. Likewise, plural terms shall include the singular unless otherwise required by context. The use of the term “or” in the present disclosure (including the claims) is used to mean an inclusive “and/or” unless explicitly indicated to refer to alternatives only or unless the alternatives are mutually exclusive.

Unless otherwise explicitly stated as incompatible, or the physics or otherwise of the embodiments, examples, or claims prevent such a combination, the features of examples disclosed herein, and of the claims, may be integrated together in any suitable arrangement, especially ones where there is a beneficial effect in doing so. This is not limited to only any specified benefit, and instead may arise from an “ex post facto” benefit. This is to say that the combination of features is not limited by the described forms, particularly the form (e.g., numbering) of example(s), embodiment(s), or dependency of claim(s). In the preceding embodiments, the functions described may be implemented in hardware, software, firmware, or any combination thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave may be included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

The following clauses set out further aspects and embodiments.
1. A method in a wireless network, the wireless network comprising a wireless access backhaul, WAB, node comprising a mobile termination, MT, component and a gNB component, wherein the MT component of the WAB node is being served by a backhaul NG-RAN node, BH-RAN-node, in the wireless network, the method at the gNB component of the WAB node comprising: initiating a resource coordination with the BH-RAN-node, wherein initiating the resource coordination comprises transmitting a request for resource coordination between the gNB component of the WAB node and the BH-RAN-node, wherein the request for resource coordination comprises an indication of a co-location of the MT component and the gNB component in the WAB node.
2. The method of clause 1, wherein the indication of the co-location is co-location information comprising an identifier of the gNB component of the WAB node and an identifier of the MT component allocated by the BH-RAN node.
3. The method of any of clause 1 or 2, wherein the method further comprises: receiving a response accepting or rejecting the request for resource coordination.
4. The method of clause 3, wherein the response accepts the request for resource coordination, the method further comprising: performing a resource coordination with the BH-RAN-node.
5. The method of clause 3, wherein the response rejects the request for resource coordination, and wherein the response further indicates a reason that the request for resource coordination has been rejected.
6. The method of clause 5, wherein the response includes cause information for indicating the reason that the request for resource coordination has been rejected.
7. The method of any of clauses 1-6, wherein the method further comprises, prior to transmitting the request for resource coordination: obtaining status information associated with the WAB node; and based on status information, determining to transmit the request for resource coordination.
8. The method of clause 7, wherein the status information associated with the WAB node comprises at least one of: information indicating the expected trajectory of the WAB node; information indicating a current speed of the WAB node; and information indicating a current velocity of the WAB node.
9. A method in a wireless network, the wireless network comprising a wireless access backhaul, WAB, node comprising a mobile termination, MT, component and a gNB component, wherein the MT component of the WAB node is being served by a first NG-RAN node in the wireless network, and the wireless network further comprising a second NG-RAN node, the method at the gNB component of the WAB node comprising: initiating a resource coordination with the second NG-RAN node.
10. The method of clause 9, wherein initiating the resource coordination with the second NG-RAN node comprises: transmitting a request for resource coordination between the gNB component of the WAB node and the second NG-RAN node.
11. The method of clause 10, wherein the request for resource coordination is transmitted to the second NG-RAN node, or to the first NG-RAN node.
12. The method of clause 10 or 11, wherein the request for resource coordination comprises an identifier of the gNB component of the WAB node and/or an identifier of the second NG-RAN node.
13. The method of any of clauses 10-12, wherein the request for resource coordination comprises an indication of a co-location of the MT component and the gNB component in the WAB node.
14. The method of any of clauses 10-13, wherein the method further comprises: receiving a response accepting or rejecting the request for resource coordination between the gNB component of the WAB node and the second NG-RAN node.
15. The method of clause 14, wherein the response accepting or rejecting the request for resource coordination is received from the second NG-RAN node, or from the first NG-RAN node.
16. The method of clause 14 or 15, wherein the response accepts the request for resource coordination between the gNB component of the WAB node and the second NG-RAN node, the method further comprising: performing a resource coordination with the second NG-RAN node.
17. The method of clause 14 or 15, wherein the response rejects the request for resource coordination, and wherein the response further indicates a reason that the request for resource coordination has been rejected.
18. The method of clause 14, wherein the response includes cause information for indicating the reason that the request for resource coordination has been rejected.
19. The method of any of clauses 14-18, wherein the response to the request for resource coordination comprises an identifier of the gNB component of the WAB node and/or an identifier of the second NG-RAN node.
20. The method of any of clauses 10-19, wherein the method further comprises, prior to transmitting the request for resource coordination: obtaining status information associated with the WAB node; and based on status information, determining to transmit the request for resource coordination.
21. The method of clause 20, wherein the status information associated with the WAB node comprises at least one of: information indicating the expected trajectory of the WAB node; information indicating a current speed of the WAB node; and information indicating a current velocity of the WAB node.
22. The method of any preceding clause, wherein the first NG-RAN node is a source backhaul RAN node, source BH-RAN-node, wherein the second NG-RAN node is a target BH-RAN-node, and wherein the step of initiating the resource coordination is performed in response to an initiation of a handover procedure of the MT component between the source BH-RAN-node and the target BH-RAN-node.
23. The method of clause 22, wherein prior to initiating the resource coordination, the method further comprises: receiving, from the source BH-RAN-node, information identifying the target BH-RAN-node and information identifying the MT component at the target BH-RAN-node.
24. The method of clause 22 or 23, wherein prior to initiating the resource coordination, the method further comprises: establishing an Xn connection with the target BH-RAN-node.
25. The method of any of clauses 9-21, wherein the first NG-RAN node is a master node, MN , for dual-connectivity of the MT component of the WAB node, wherein the second NG-RAN node is a secondary node, SN, for dual-connectivity of the MT component of the WAB node, and wherein the step of initiating the resource coordination is performed in response to an initiation of a procedure to configure dual connectivity for the MT component of the WAB node.
26. The method of clause 25, wherein prior to initiating the resource coordination, the method further comprises: receiving, from the MN, information identifying the SN and information identifying the MT component at the SN.
27. The method of any of clauses 25-26, wherein prior to initiating the resource coordination, the method further comprises: establishing an Xn connection with the SN.
28. The method of any of clauses 9-21, wherein the first NG-RAN node is a backhaul RAN node, BH- RAN-node, wherein the second NG-RAN node is a master node, MN for dual-connectivity of a user equipment, UE, and wherein the gNB component of the WAB node is a secondary node, SN, for dual-connectivity of the UE.
29. A method in a wireless network, the wireless network comprising a wireless access backhaul, WAB, node comprising a mobile termination, MT, component and a gNB component, wherein the MT component is being served by a first NG-RAN node in the wireless network, and the wireless network further comprising a second NG-RAN node, the method at the gNB component of the WAB node comprising: receiving a request for resource coordination between the gNB component of the WAB node and the second NG-RAN node; and transmitting a response accepting or rejecting the request for resource coordination between the gNB component of the WAB node and the second NG-RAN node.
30. The method of clause 29, wherein the request for resource coordination is received from the second NG-RAN node, or from the first NG-RAN node.
31. The method of clause 29 or 30, wherein the request for resource coordination comprises an identifier of the gNB component of the WAB node and/or an identifier of the second NG-RAN node.
32. The method of any of clauses 29-31, wherein the request for resource coordination comprises cause information indicating the reason that resource coordination has been requested.
33. The method of any of clauses 29-32, wherein the response accepting or rejecting the request for resource coordination is transmitted to the second NG-RAN node, or transmitted to the first NG-RAN node.
34. The method of any of clauses 29-33, wherein the response accepts the request for resource coordination between the gNB component of the WAB node and the second NG-RAN node, and the method further comprises: performing a resource coordination with the second NG-RAN node.
35. The method of any of clauses 29-33, wherein the response rejects the request for resource coordination, and wherein the response further indicates a reason that the request for resource coordination has been rejected.
36. The method of clause 35, wherein the response includes cause information for indicating the reason that the request for resource coordination has been rejected.
37. The method of any of clauses 29-36, wherein the response to the request for resource coordination comprises an identifier of the gNB component of the WAB node and/or an identifier of the second NG-RAN node.
38. The method of any of clauses 29-37, wherein the method further comprises, prior to transmitting the response to the request for resource coordination: obtaining status information associated with the WAB node; and based on status information, determining to whether to accept or reject the request for resource coordination.
39. The method of clause 38, wherein the status information associated with the WAB node comprises at least one of: information indicating the expected trajectory of the WAB node; information indicating a current speed of the WAB node; and information indicating a current velocity of the WAB node.
40. The method of any of clauses 29-39, wherein the first NG-RAN node is a source backhaul RAN node, source BH-RAN-node, wherein the second NG-RAN node is a target BH-RAN-node, and wherein the step of receiving a request for resource coordination is performed following an initiation of a handover procedure of the MT component between the source BH-RAN-node and the target BH-RAN-node.
41. The method of any of clauses 29-40, wherein the first NG-RAN node is a master node backhaul, MN, for dual-connectivity of the MT component of the WAB node, wherein the second NG-RAN node is a secondary node, SN B, for dual-connectivity of the MT component of the WAB node, and wherein the step of initiating the resource coordination is performed in response to an initiation of a procedure to configure dual connectivity for the MT component of the WAB node.
42. The method of any of clauses 29-40, wherein the first NG-RAN node is a backhaul RAN node, BH-RAN-node, wherein the second NG-RAN node is a master node, MN, for dual-connectivity of a user equipment, UE, and wherein the gNB component of the WAB node is a secondary node , SN, for dual-connectivity of the UE.
43. A method in a wireless network, the wireless network comprising a wireless access backhaul, WAB, node comprising a mobile termination, MT, component and a gNB component, wherein the MT component is being served by a first NG-RAN node in the wireless network, and the wireless network further comprising a second NG-RAN node, the method at the second NG-RAN node comprising: initiating a resource coordination with the gNB component of the WAB node.
44. The method of clause 43, wherein, prior to the second NG-RAN node initiating a resource coordination with the gNB component of the WAB node, the method further comprises: receiving, from the first NG-RAN node, information identifying the gNB component.
45. The method of clause 43 or clause 44, wherein initiating the resource coordination with the gNB component of the WAB node comprises: transmitting a request for resource coordination between the gNB component of the WAB node and the second NG-RAN node.
46. The method of clause 45, wherein the request for resource coordination is transmitted to the gNB component of the WAB node, or to the first NG-RAN node.
47. The method of clause 45 or clause 46, wherein the request for resource coordination comprises an identifier of the gNB component of the WAB node and/or an identifier of the second NG-RAN node.
48. The method of any of clauses 45-47, wherein the request for resource coordination comprises cause information for indicating the reason that resource coordination has been requested.
49. The method of any of clauses 45-48 wherein the method further comprises: receiving a response accepting or rejecting the request for resource coordination between the gNB component of the WAB node and the second NG-RAN node.
50. The method of clause 49, wherein the response accepting or rejecting the request for resource coordination is received from the gNB component of the WAB node, or from the first NG-RAN node.
51. The method of clause 49 or clause 50, wherein the response accepts the request for resource coordination between the gNB component of the WAB node and the second NG-RAN node, and the method further comprises: performing a resource coordination with the gNB component of the WAB node.
52. The method of clause 49 or clause 50, wherein the response rejects the request for resource coordination, and wherein the response further indicates a reason that the request for resource coordination has been rejected.
53. The method of clause 52, wherein the response includes cause information for indicating the reason that the request for resource coordination has been rejected.
54. The method of any of clauses 49-53, wherein the response to the request for resource coordination comprises an identifier of the gNB component of the WAB node and/or an identifier of the second NG-RAN node.
55. The method of any of clauses 45-54, wherein the method further comprises, prior to transmitting the request for resource coordination: obtaining status information associated with the WAB node; and based on status information, determining to transmit the request for resource coordination.
56. The method of clause 55, wherein the status information associated with the WAB node comprises at least one of: information indicating the expected trajectory of the WAB node; information indicating a current speed of the WAB node; and information indicating a current velocity of the WAB node.
57. The method of any of clauses 45-56, wherein the first NG-RAN node is a source backhaul RAN node, source BH-RAN-node, wherein the second NG-RAN node is a target BH-RAN-node, and wherein the step of initiating the resource coordination is performed in response to an initiation of a handover procedure of the MT component between the source BH-RAN-node and the target BH-RAN-node.
58. The method of clause 57, when dependent on clause 44, wherein the information identifying the gNB component is received in a handover request message.
59. The method of clause 57 or clause 58, wherein prior to initiating the resource coordination, the method further comprises: establishing an Xn connection with the gNB component of the WAB node.
60. The method of any of clauses 45-56, wherein the first NG-RAN node is a master node, MN, for dual-connectivity of the MT component of the WAB node, wherein the second NG-RAN node is a secondary node RAN-node, SN, for dual-connectivity of the MT component of the WAB node, and wherein the step of initiating the resource coordination is performed in response to an initiation of a procedure to configure dual connectivity for the MT component of the WAB node.
61. The method of clause 57, when dependent on clause 44, wherein the information identifying the gNB component is received in a SN addition request message.
62. The method of clause 60 or clause 61, wherein prior to initiating the resource coordination, the method further comprises: establishing an Xn connection with the SN.
63. The method of any of clauses 45-56, wherein the first NG-RAN node is a backhaul RAN node, BH-RAN-node, wherein the second NG-RAN node is a master node, MN for a user equipment, UE, and wherein the gNB component of the WAB node is a secondary node , SN , for the UE.
64. A method in a wireless network, the wireless network comprising a wireless access backhaul, WAB, node comprising a mobile termination, MT, component and a gNB component, wherein the MT component is being served by a first NG-RAN node in the wireless network, and the wireless network further comprising a second NG-RAN node, the method at the second NG-RAN node comprising: receiving a request for resource coordination between the gNB component of the WAB node and the second NG-RAN node; and transmitting a response accepting or rejecting the request for resource coordination between the gNB component of the WAB node and the second NG-RAN node.
65. The method of clause 64, wherein the request for resource coordination is received from the gNB component of the WAB node, or from the first NG-RAN node.
66. The method of clause 64 or clause 65, wherein the request for resource coordination comprises an identifier of the gNB component of the WAB node and/or an identifier of the second NG-RAN node.
67. The method of any of clauses 64-66, wherein request for resource coordination comprises cause information for indicating the reason that resource coordination has been requested.
68. The method of any of clauses 64-67, wherein the request for resource coordination comprises an indication of a co-location of the MT component and the gNB component in the WAB node.
69. The method of any of clauses 64-68, wherein the response accepting or rejecting the request for resource coordination is transmitted to the gNB component of the WAB node, or transmitted to the first NG-RAN node.
70. The method of any of clauses 64-69, wherein the response accepts the request for resource coordination between the gNB component of the WAB node and the second NG-RAN node, and the method further comprises: performing a resource coordination with the gNB component of the WAB node.
71. The method of any of clauses 64-69, wherein the response rejects the request for resource coordination, and wherein the response further indicates a reason that the request for resource coordination has been rejected.
72. The method of clause 71, wherein the response includes cause information for indicating the reason that the request for resource coordination has been rejected.
73. The method of any of clauses 64-72, wherein the response to the request for resource coordination comprises an identifier of the gNB component of the WAB node and/or an identifier of the second NG-RAN node.
74. The method of any of clauses 64-73, wherein the method further comprises, prior to transmitting the response to the request for resource coordination: obtaining status information associated with the WAB node; and based on status information, determining to whether to accept or reject the request for resource coordination.
75. The method of clause 74, wherein the status information associated with the WAB node comprises at least one of: information indicating the expected trajectory of the WAB node; information indicating a current speed of the WAB node; and information indicating a current velocity of the WAB node.
76. The method of any of clauses 64-75, wherein the first NG-RAN node is a source backhaul RAN node, source BH-RAN-node, wherein the second NG-RAN node is a target BH-RAN-node, and wherein the step of receiving a request for resource coordination is performed following an initiation of a handover procedure of the MT component between the source BH-RAN-node and the target BH -RAN-node.
77. The method of any of clauses 64-75, wherein the first NG-RAN node is a master node, MN, for dual-connectivity of the MT component of the WAB node, wherein the second NG-RAN node is a secondary node, SN , for dual-connectivity of the MT component of the WAB node, and wherein the step of initiating the resource coordination is performed in response to an initiation of a procedure to configure dual connectivity for the MT component of the WAB node.
78. The method of any of clauses 64-75, wherein the first NG-RAN node is a backhaul RAN node, BH-RAN-node, wherein the second NG-RAN node is a master node, MN for dual-connectivity of a user equipment, UE, and wherein the gNB component of the WAB node is a secondary node, SN, for dual-connectivity of the UE.
79. A computer program comprising instructions which, when the program is executed by at least one processor unit, cause the at least one processing unit to carry out the method according to any one of clauses 1 to 78.
80. A computer-readable medium carrying a computer program according to clause79.
81. An apparatus for a gNB component of a wireless access backhaul, WAB, node, the apparatus comprising: one or more processing units configured to perform the method as recited in any one of clauses 1 to 42.
82. An apparatus for a second NG-RAN node e, the apparatus comprising: one or more processing units configured to perform the method as recited in any one of clauses 43 to 78.

1. A method in a wireless network, the wireless network comprising a wireless access backhaul, WAB, node comprising a mobile termination, MT, component and a gNB component, wherein the MT component of the WAB node is being served by a backhaul NG-RAN node, BH-RAN-node, in the wireless network, the method at the gNB component of the WAB node comprising:
initiating a resource coordination with the BH-RAN-node, wherein initiating the resource coordination comprises transmitting a request for resource coordination between the gNB component of the WAB node and the BH-RAN-node, wherein the request for resource coordination comprises an indication of a co-location of the MT component and the gNB component in the WAB node.

2. The method of claim 1, wherein the indication of the co-location is co-location information comprising an identifier of the gNB component of the WAB node and an identifier of the MT component allocated by the BH-RAN node.

3. The method of claim 1, wherein the method further comprises:
receiving a response accepting or rejecting the request for resource coordination.

4. The method of claim 3, wherein the response accepts the request for resource coordination, the method further comprising:
performing a resource coordination with the BH-RAN-node.

5. The method of claim 3, wherein the response rejects the request for resource coordination, and wherein the response further indicates a reason that the request for resource coordination has been rejected.

6. The method of claim 1, wherein the method further comprises, prior to transmitting the request for resource coordination:
obtaining status information associated with the WAB node; and
based on status information, determining to transmit the request for resource coordination.

7. A method in a wireless network, the wireless network comprising a wireless access backhaul, WAB, node comprising a mobile termination, MT, component and a gNB component, wherein the MT component of the WAB node is being served by a first NG-RAN node in the wireless network, and the wireless network further comprising a second NG-RAN node, the method at the gNB component of the WAB node comprising:
initiating a resource coordination with the second NG-RAN node.

8. The method of claim 7, wherein initiating the resource coordination with the second NG-RAN node comprises:
transmitting, to the second NG-RAN node, or to the first NG-RAN node, a request for resource coordination between the gNB component of the WAB node and the second NG-RAN node.

9. The method of claim 8, wherein the request for resource coordination comprises an identifier of the gNB component of the WAB node and/or an identifier of the second NG-RAN node.

10. The method of claim 8, wherein the method further comprises:
receiving, from the second NG-RAN node, or from the first NG-RAN node, a response accepting or rejecting the request for resource coordination between the gNB component of the WAB node and the second NG-RAN node.

11. The method of claim 10, wherein the response accepts the request for resource coordination between the gNB component of the WAB node and the second NG-RAN node, the method further comprising:
performing a resource coordination with the second NG-RAN node.

12. The method of claim 7, wherein the first NG-RAN node is a source backhaul RAN node, source BH-RAN-node, wherein the second NG-RAN node is a target BH-RAN-node, and wherein the step of initiating the resource coordination is performed in response to an initiation of a handover procedure of the MT component between the source BH-RAN-node and the target BH-RAN-node.

13. The method of claim 7, wherein the first NG-RAN node is a master node, MN , for dual-connectivity of the MT component of the WAB node, wherein the second NG-RAN node is a secondary node, SN, for dual-connectivity of the MT component of the WAB node, and wherein the step of initiating the resource coordination is performed in response to an initiation of a procedure to configure dual connectivity for the MT component of the WAB node.

14. A method in a wireless network, the wireless network comprising a wireless access backhaul, WAB, node comprising a mobile termination, MT, component and a gNB component, wherein the MT component is being served by a first NG-RAN node in the wireless network, and the wireless network further comprising a second NG-RAN node, the method at the gNB component of the WAB node comprising:
receiving a request for resource coordination between the gNB component of the WAB node and the second NG-RAN node; and
transmitting a response accepting or rejecting the request for resource coordination between the gNB component of the WAB node and the second NG-RAN node.

15. The method of claim 14, wherein the request for resource coordination is received from the second NG-RAN node, or from the first NG-RAN node.

16. The method of claim 14, wherein the response accepting or rejecting the request for resource coordination is transmitted to the second NG-RAN node, or transmitted to the first NG-RAN node.

17. The method of claim 14, wherein the response accepts the request for resource coordination between the gNB component of the WAB node and the second NG-RAN node, and the method further comprises:
performing a resource coordination with the second NG-RAN node.

18. A method in a wireless network, the wireless network comprising a wireless access backhaul, WAB, node comprising a mobile termination, MT, component and a gNB component, wherein the MT component is being served by a first NG-RAN node in the wireless network, and the wireless network further comprising a second NG-RAN node, the method at the second NG-RAN node comprising:
initiating a resource coordination with the gNB component of the WAB node.

19. The method of claim 18, wherein, prior to the second NG-RAN node initiating a resource coordination with the gNB component of the WAB node, the method further comprises:
receiving, from the first NG-RAN node, information identifying the gNB component.

20. The method of claim 18, wherein initiating the resource coordination with the gNB component of the WAB node comprises:
transmitting, to the gNB component of the WAB node, or to the first NG-RAN node, a request for resource coordination between the gNB component of the WAB node and the second NG-RAN node.

21. The method of claim 20, wherein the request for resource coordination comprises an identifier of the gNB component of the WAB node and/or an identifier of the second NG-RAN node.

22. The method of claim 20 wherein the method further comprises:
receiving, from the gNB component of the WAB node, or from the first NG-RAN node, a response accepting or rejecting the request for resource coordination between the gNB component of the WAB node and the second NG-RAN node.

23. The method of claim 22, wherein the response accepts the request for resource coordination between the gNB component of the WAB node and the second NG-RAN node, and the method further comprises:
performing a resource coordination with the gNB component of the WAB node.

24. The method of claim 20, wherein the first NG-RAN node is a source backhaul RAN node, source BH-RAN-node, wherein the second NG-RAN node is a target BH-RAN-node, and wherein the step of initiating the resource coordination is performed in response to an initiation of a handover procedure of the MT component between the source BH-RAN-node and the target BH-RAN-node.

25. The method of claim 20, wherein the first NG-RAN node is a master node, MN, for dual-connectivity of the MT component of the WAB node, wherein the second NG-RAN node is a secondary node RAN-node, SN, for dual-connectivity of the MT component of the WAB node, and wherein the step of initiating the resource coordination is performed in response to an initiation of a procedure to configure dual connectivity for the MT component of the WAB node.

26. An apparatus for a gNB component of a wireless access backhaul, WAB, node of a wireless network, the apparatus comprising:
one or more processing units configured to:
in a case where a MT component of the WAB node is being served by a backhaul NG-RAN node, BH-RAN-node, in the wireless network, initiate a resource coordination with the BH-RAN-node, wherein initiating the resource coordination comprises transmitting a request for resource coordination between the gNB component of the WAB node and the BH-RAN-node, wherein the request for resource coordination comprises an indication of a co-location of the MT component and the gNB component in the WAB node.
